(19) United States
(12) Patent Application Publication
(10) Pub. No.: US 2020/0024686 A1
(43) Pub. Date: Jan. 23, 2020

(54) Combined Processing Method for Lithium Containing Solutions

(71) Applicant: Inneovation Pty Ltd, West Perth, Western Australia (AU)

(72) Inventor: Christopher John REED, Swanbourne (AU)

(21) Appl. No.: 16/483,774

(22) PCT Filed: Feb. 8, 2017
(86) PCT No.: PCT/AU2017/050099

§ 371 Date: Aug. 6, 2019

(51) Int. Cl. C22B 26/12; C01D 15/04; C01G 23/00; C22B 3/24

(52) U.S. Cl. CPC C22B 26/12; C01D 15/04; C01G 23/005; C01P 2006/80; C01P 2004/04; C01P 2004/13; C01P 2006/12; C22B 3/24

(57) ABSTRACT

A combined processing method for the purification of lithium containing solutions, the method comprising the method steps of passing a lithium containing solution to a first purification step in which the lithium containing solution is contacted with a titanate adsorbent whereby lithium ions are adsorbed thereon whilst rejecting substantially all other cations, the recovery of lithium from the adsorbent providing a part-purified lithium containing solution, the part-purified lithium containing solution produced in the first purification step is then passed in whole or part to a second purification step in which a graphene based filter medium is utilised to provide a further purified lithium containing solution.

### FIELD OF THE INVENTION

The present invention relates to a combined processing method for lithium containing solutions.

More particularly, the method of the present invention is intended for use in the extraction of lithium chloride from a lithium containing brine. In one form the extraction of lithium chloride from a lithium containing brine is achieved through the combined action of an adsorbent and a filter utilising a graphene based filter medium.

The present invention further relates to the synthesis of an adsorbent derived from titanium dioxide, such as sodium titanate (Na₂Ti₃O₇) or hydrogen titanate (H₂TiO₃), and a process for the extraction of lithium chloride from a lithium containing solution, such as a brine, from such adsorbent. More particularly, the lithium chloride is extracted from a brine solution through adsorption on an adsorbent, for example sodium titanate (Na₂Ti₃O₇) or hydrogen titanate (H₂TiO₃), synthesised from titanium dioxide.

The present invention still further relates to a process for the purification of semi-pure lithium chloride obtained through adsorption of lithium on an adsorbent, such as sodium titanate or hydrogen titanate, to prepare high purity lithium chloride solution for use in battery applications. This is particularly achieved through a process in which the semi-pure lithium chloride solution obtained through desorption on adsorbent is passed through a graphene based membrane.

The graphene based filter medium employed in the process of the present invention is particularly, in one form, graphene oxide (GO) or reduced graphene oxide (rGO). It is envisaged that the graphene based filter medium acts as an ion sieve, allowing ions with smaller sizes than those of the channels to permeate while blocking all other larger species. In this manner it is understood that the graphene based filter medium rejects impurities such as K, Na and Mg, allowing the purification of a LiCl containing solution.

### Background Art

Lithium chloride (LiCl) has widespread commercial application. It is used in the production of lithium metal, lithium carbonate and lithium hydroxide monohydrate for various battery applications. Due to the requirement for high purity in many of these applications, particularly when used as a cathode material in lithium ion batteries, there is an ever increasing need for high purity lithium chloride.

Traditionally, LiCl from a brine source is purified by solar evaporation technology to concentrate the brine solution and thereby remove sodium and potassium impurities. Other impurities, such as boron, may be removed by solvent extraction technology, whereas calcium, magnesium and other similar impurities may be removed by increasing the pH of the brine solution. This is typically achieved through the addition of lime and the formation and precipitation of insoluble salts, including calcium carbonate. This is very time consuming and highly dependent on the weather. Therefore, a purification means is needed to remove the majority of the impurities from a LiCl solution derived from a brine source, such that the concentration of each impurity is reduced to less than about 20 ppm.

An impurity concentration of less than about 20 ppm makes the resulting LiCl solution suitable for use in lithium metal extraction or the preparation of other lithium compounds, including lithium carbonate and lithium hydroxide monohydrate, for use in lithium ion battery applications.

The processes of the present invention have as one object thereof to overcome substantially one or more of the above mentioned problems associated with prior art, or to at least provide a useful alternative thereto.

The preceding discussion of the background art is intended to facilitate an understanding of the present invention only. This discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

The term brine, or brines, or variations thereof, is to be understood to include a solution of alkali and/or alkaline earth metal salt(s) in water, of a natural or possibly industrial source. The concentrations of the various salts can vary widely. The ions present in brine may include a combination of one or more of a monovalent cation, such as lithium, multivalent cations, monovalent anions, and multivalent anions.

The term high purity lithium chloride is to be understood, unless the context requires otherwise, as requiring any impurity present to be present in amounts of less than about 20 ppm.

The term graphene, graphene sheet or graphene material is to be understood, unless the context requires otherwise, as including single layer graphene, few layer graphene (FLG), graphene nano-platelets, graphene nanotubes, graphene nanoribbons, graphene nano-sheets and the like.

### DISCLOSURE OF THE INVENTION

In accordance with the present invention there is provided a combined processing method for the purification of lithium containing solutions, the method comprising the method steps of passing a lithium containing solution to a first purification step in which the lithium containing solution is contacted with a titanate adsorbent whereby lithium ions are adsorbed thereon whilst rejecting substantially all other cations, the recovery of the lithium from the adsorbent providing a part-purified lithium containing solution, the part-purified lithium containing solution produced in the first purification step is then passed in whole or part to a second purification step in which a graphene based filter medium is utilised to provide a further purified lithium containing solution.

In one form, the lithium containing solution is a lithium containing brine.

Preferably, the adsorbent is provided in the form of either a hydrated titanium dioxide or a sodium titanate. In one form of the present invention the hydrated titanium dioxide is produced from titanium dioxide.

Still preferably, the process in turn produces a substantially pure lithium chloride solution.

The brine preferably contains impurities from the group of sodium, potassium, magnesium, calcium and borate.

Still preferably, the impurity concentration of the substantially pure lithium chloride solution does not exceed about 20 ppm.

In one form of the present invention the brine contains lithium in the range of about 500 to 1500 ppm, and impurities including magnesium in the range of about 0.15% to 0.30%, calcium in the range of about 0.05% to 0.1%, sodium in the range of about 8 to 10%, potassium in the range of about 0.7% to 1.0%, and borate in the range of about 0.15% to 0.20%.

In a more preferred form of the present invention, the brine contains about 700 ppm lithium, about 0.19% magnesium, about 0.09% calcium, about 8.8% sodium, about 0.8% potassium and about 0.18% borate.

The brine solution is preferably adjusted to a pH of 7 through the addition of a base. The base is preferably provided in the form of sodium hydroxide.

The contact between the brine solution and the adsorbent preferably takes place at or about room or ambient temperature.

In one form of the present invention the brine is collected into a vessel and cooled to room temperature prior to its exposure to the adsorbent. Preferably, room temperature is understood to be between about 20° C. to 28° C.

Preferably, the contact or residence time between the brine solution and the adsorbent is between about 4 to 24 hours.

Still preferably, the contact or residence time between the brine solution and the adsorbent is:
a) between about 8 to 24 hours;
b) between about 20 to 24 hours; or
c) between about 8 to 16 hours.

It is to be understood that the contact time is to some extent dependent upon additional variables including reactor size and shape.

Preferably, the recovery of lithium from the adsorbent is achieved through the regeneration of the adsorbent by the addition of an acid solution and the adsorbed lithium is extracted to provide the part purified lithium containing solution. Still preferably, the acid solution is a solution of hydrochloric acid.

Still further preferably, the amount of lithium extracted from the adsorbent through exposure to the acid solution is greater than about 90%. Yet still preferably, the amount of lithium extracted from the adsorbent through exposure to the acid solution is about 100% of the adsorbed lithium.

The graphene based filter medium of the second purification step preferably comprises a graphene membrane formed of one or more graphene, graphene oxide and/or reduced graphene oxide and to which the part-purified lithium containing solution is presented.

The passing of the part purified lithium containing solution to the second purification step produces a filtrate or permeate that is enriched in relative terms in lithium ions, providing the further purified lithium containing solution.

Preferably, the second purification step is conducted under pressure. The pressure may be 10 bar.

Preferably, the further purified lithium containing solution is suitable is suitable for use in the production of battery grade lithium chemicals.

In one form, the graphene is provided as a graphene oxide membrane formed in turn from graphite oxide powder. The graphene oxide membrane may preferably be supported on a first support that is in turn located in an aperture of a second support.

Preferably the first support is an anodic alumina disc. Still preferably, the second support is a copper plate.

In one form the graphene is provided as a reduced graphene oxide membrane. The graphene oxide membrane may preferably be reduced by way of exposure to ascorbic acid.

The area used for pressure filtration is preferably about 1-2 cm2. Preferably, the membranes may be further supported by a porous substrate. In one form the porous substrate may be provided in the form of polyether sulfone (PES).

Preferably, an adhesive material is applied to the porous substrate to increase the bond between the substrate and the graphene material. Still preferably, the adhesive material is provided in the form of a polymer. Still further preferably, the polymer is a positively charged polymer.

In one form the positively charged polymer is polydiallyldimethulammonium chloride.

Preferably, the graphene membrane has a thickness of between 30 to 200 nm. Still preferably, the thickness of the graphene membrane is 150 to 200 nm.

Preferably, the salt rejection achieved by the second purification step is 20% or greater as measured by the conductivity of the permeate relative to that of the part-purified lithium containing solution.

Still preferably, lithium is the least rejected ion or salt of the second purification step.

In one form, the first and second purification steps may comprise one or more stages, passes or repeats of contact or exposure between the lithium containing solution passed to them and the adsorbent or filter medium, respectively.

In accordance with the present invention there is further provided a process for the synthesis of a titanate adsorbent.

Preferably, the titanate adsorbent is provided in the form of sodium titanate (Na₂Ti₃O₇) and hydrogen titanate (H₂TiO₃).

Still preferably, the titanate adsorbent formed in accordance with this process is suitable for the extraction of lithium from a lithium containing solution. The lithium containing solution may be a brine.

The brine contains impurities from the group of sodium, potassium, magnesium, calcium and borate.

### BRIEF DESCRIPTION OF THE DRAWINGS

The present invention will now be described, by way of example only, with reference to one embodiment thereof and the accompanying drawings, in which:

FIG. 1 is an XRD pattern of a pristine TiO₂ powder;

FIG. 2 is a TEM image of pristine TiO₂;

FIG. 3 is an XRD Pattern of a Na₂Ti₃O₇ prepared at 120° C.;

FIG. 4 is an XRD Pattern of an Na₂Ti₃O₇ prepared at 150° C.;

FIG. 5 is a an XRD Pattern of Na₂Ti₃O₇ prepared at 180° C.;

FIG. 6 is a TEM image of Na₂Ti₃O₇ Prepared at 120° C.;

FIG. 7 is a TEM image of Na₂Ti₃O₇ Prepared at 150° C.;

FIG. 8 is a TEM image of Na₂Ti₃O₇ Prepared at 180° C.;

FIG. 9 is the XRD patterns of Li₂TiO₃ and H₂TiO₃ as per Example 3;

FIG. 10 is a TEM image of Li₂TiO₃;

FIG. 11 is a TEM image of H₂TiO₃;

FIG. 12 is an XRD pattern of Na₂Ti₃O₇ (Synthesised at 120° C.) after Adsorption Test;

FIG. 13 is an XRD pattern of Na₂Ti₃O₇ (Synthesised at 120° C.) after Adsorption Test;

FIG. 14 is a TEM image of Na₂Ti₃O₇ (Synthesised at 120° C.) after Adsorption Test;

FIG. 15 is an XRD pattern of Na₂Ti₃O₇ (Synthesised at 150° C.) after Adsorption Test;

FIG. 16 is an XRD pattern of Na₂Ti₃O₇ (Synthesised at 150° C.) after Adsorption Test;

FIG. 17 is TEM image of Na₂Ti₃O₇ (Synthesised at 150° C.) after Adsorption Test;

FIG. 18 is an XRD pattern of Na₂Ti₃O₇ (Synthesised at 180° C.) after Adsorption Test;

FIG. 19 is an XRD pattern of Na₂Ti₃O₇ (Synthesised at 180° C.) after Adsorption Test;

FIG. 20 is TEM image of Na₂Ti₃O₇ (Synthesised at 180° C.) after Adsorption Test;

FIG. 21 is a kinetic adsorption test of sodium titanate Na₂Ti₃O₇ sorbent synthesizes at 150° C. in 100 ml brine solution (˜300 ppm Li);

FIG. 22 is a kinetic adsorption test of sodium titanate Na₂Ti₃O₇ sorbent synthesizes at 150° C. in 100 ml brine solution (˜300 ppm Li);

FIGS. 23(a) to 23(d) are the XRD characterisations for sodium titanate (Na₂Ti₃O₇) synthesised at 150° C. sorbents, observed at 4 sampling times;

FIG. 24 shows BET surface areas of sodium titanate synthesizes at 120° C., 150° C. and 180° C. observed before and after adsorption;

FIG. 25 shows the kinetics of 3g sodium titanate sorbent prepared at 150° C. (Na₂Ti₃O_{7 150}) for 100 mL brine solution with different concentrations of Li⁺ ions and at different times of adsorption;

FIG. 26 shows the kinetics of 10 g sodium titanate sorbent prepared at 150° C. (Na₂Ti₃O_{7 150}) for 100 mL brine solution with different concentrations of Li⁺ ions and at different times of adsorption;

FIG. 27 shows an increased in amount of sorbent to 100 g/100 mL of brine solution (sorbent prepared at 150° C.—Na₂Ti₃O₇ 150) for different concentrations f Li⁺ ions and at different times of adsorption;

FIG. 28 shows the results of the kinetic adsorption tests of hydrogen titanate sorbent (H₂TiO₃) in sorbent to solution ratio: 3 g-100 mL brine solution (˜300 ppm Li);

FIG. 29 shows the results of the kinetic adsorption tests of hydrogen titanate sorbent (H₂TiO₃) in sorbent to solution ratio: 10 g-100 mL brine solution (˜300 ppm Li);

FIG. 30 shows the results of the kinetic adsorption tests of hydrogen titanate sorbent (H₂TiO₃) in sorbent to solution ratio: 100 g-1000 mL brine solution (˜300 ppm Li);

FIG. 31 shows XRD data of the sorbent hydrogen titanate sorbent (H₂TiO₃) before and after adsorption at different times;

FIG. 32 shows BET surface area data of the sorbent hydrogen titanate sorbent (H₂TiO₃) before and after adsorption;

FIG. 33 shows the reaction kinetics of 3 g hydrogen titanate sorbent (H₂TiO₃), 100 mL brine solution with different concentrations of with different concentrations of Li⁺ ions;

FIG. 34 shows the reaction kinetics of 10 g hydrogen titanate sorbent (H₂TiO₃), 100 mL brine solution with different concentrations of with different concentrations of Li⁺ ions;

FIG. 35 shows the reaction kinetics of 100 g hydrogen titanate sorbent (H₂TiO₃), 1000 mL brine solution with different concentrations of with different concentrations of Li⁺ ions;

FIG. 36 shows the results of kinetic desorption testing for TNT-120;

FIG. 37 shows the results of kinetic desorption testing for TNT-150;

FIG. 38 shows the results of kinetic desorption testing for TNT-180;

FIG. 39 shows the desorption data for hydrogen titanate sorbent (H₂TiO₃);

FIG. 40 shows XRD patterns of TNT-120 sorbent after adsorption in 300 ppm Li⁺ solution;

FIG. 41 shows XRD patterns of TNT-150 sorbent after adsorption in 300 ppm Li⁺ solution;

FIG. 42 shows XRD patterns of TNT-180 sorbent after adsorption in 300 ppm Li⁺ solution;

FIG. 43 shows XRD patterns of H₂TiO₃ sorbent after adsorption in 300 ppm Li⁺ solution;

FIG. 44 shows TEM images of TNT-120 sorbents after desorption with 0.05M HCl at 25° C.;

FIG. 45 shows TEM images of TNT-150 sorbents after desorption with 0.05M HCl at 25° C.;

FIG. 46 shows TEM images of TNT-180 sorbents after desorption with 0.05M HCl at 25° C.;

FIG. 47 shows TEM images of H₂TiO₃ sorbents after desorption with 0.05M HCl at 25° C.;

FIG. 48 shows Na⁺ and Cl⁻ ion permeation through a GO membrane;

FIG. 49 shows the filtration performance of modified GO membranes with different thickness (FIG. 49a) and different reduction time (FIG. 49b); and

FIG. 50 shows the concentration of salts in a brine solution before and after filtration through a modified GO membrane, where the Y-axis—log scale and S1 and S2 represent data from two different membranes, the membrane used being 200 nm thick and 30 minute rGO.

### BEST MODE(S) FOR CARRYING OUT THE INVENTION

The present invention provides a combined processing method for the purification of lithium containing solutions, the method comprising the method steps of passing a lithium containing solution to a first purification step in which the lithium containing solution is contacted with a titanate adsorbent whereby lithium ions are adsorbed thereon whilst rejecting substantially all other cations, the recovery of the adsorbed lithium providing a part-purified lithium containing solution, the part-purified lithium containing solution produced in the first purification step is then passed in whole or part to a second purification step in which a graphene based filter medium is utilised to provide a further purified lithium containing solution.

In one form, the lithium containing solution is a lithium containing brine. The brine to be treated initially contains impurities from the group of sodium, potassium, magnesium, calcium and borate. In one form of the present invention the brine contains lithium in the range of about 500 to 1500 ppm, and impurities including magnesium in the range of about 0.15% to 0.30%, calcium in the range of about 0.05% to 0.1%, sodium in the range of about 8 to 10%, potassium in the range of about 0.7% to 1.0%, and borate in the range of about 0.15% to 0.20%. In a more preferred form of the present invention, the brine contains about 700 ppm lithium, about 0.19% magnesium, about 0.09% calcium, about 8.8% sodium, about 0.8% potassium and about 0.18% borate.

The adsorbent is provided in the form of either a hydrated titanium dioxide or a sodium titanate. In one form of the present invention the hydrated titanium dioxide is produced from titanium dioxide.

The process in turn produces a substantially pure lithium chloride solution. The impurity concentration of the substantially pure lithium chloride solution does not exceed about 20 ppm.

The brine solution is preferably adjusted to a pH of 7 through the addition of a base. The base is preferably provided in the form of sodium hydroxide.

The contact between the brine solution and the adsorbent preferably takes place at or about room or ambient temperature. Room temperature is understood to be between about 20° C. to 28° C.

In one form of the present invention the brine is collected into a vessel and cooled to room temperature prior to its exposure to the adsorbent. The contact or residence time between the brine solution and the adsorbent is between about 4 to 24 hours.

The contact or residence time between the brine solution and the adsorbent is:
a) between about 8 to 24 hours;
b) between about 20 to 24 hours; or
c) between about 8 to 16 hours.

It is to be understood that the contact time is to some extent dependent upon additional variables including reactor size and shape.

The recovery of lithium from the adsorbent is preferably achieved through the regeneration of the adsorbent by the addition of an acid solution and the adsorbed lithium is extracted to provide the part purified lithium containing solution. The acid solution is a solution of hydrochloric acid.

The amount of lithium extracted from the adsorbent through exposure to the acid solution is greater than about 90%. For example, the amount of lithium extracted from the adsorbent through exposure to the acid solution is about 100% of the adsorbed lithium.

The graphene based filter medium of the second purification step comprises a graphene membrane formed of one or more graphene, graphene oxide and/or reduced graphene oxide and to which the part-purified lithium containing solution is presented.

The passing of the part purified lithium containing solution to the second purification step produces a filtrate or permeate that is enriched in relative terms in lithium ions, providing the further purified lithium containing solution.

The second purification step is conducted under pressure. The pressure may be at or about 10 bar.

The further purified lithium containing solution is suitable is suitable for use in the production of battery grade lithium chemicals.

In one form, the graphene is provided as a graphene oxide membrane formed in turn from graphite oxide powder. The graphene oxide membrane may be supported on a first support that is in turn located in an aperture of a second support. The first support is, for example, an anodic alumina disc. The second support is, for example, a copper plate.

In one form the graphene is provided as a reduced graphene oxide membrane. The graphene oxide membrane may be reduced by way of exposure to ascorbic acid.

The area used for pressure filtration is about 1-2 cm². The membranes may be further supported by a porous substrate. In one form the porous substrate may be provided in the form of polyether sulfone (PES).

An adhesive material may applied to the porous substrate to increase the bond between the substrate and the graphene material. The adhesive material is, for example, provided in the form of a polymer. The polymer is, in one form, a positively charged polymer, for example polydiallyldimethulammonium chloride.

The graphene membrane may have a thickness of between 30 to 200 nm. For example, the thickness of the graphene membrane is 150 to 200 nm.

The level of salt rejection achieved by the second purification step is 20% or greater as measured by the conductivity of the permeate relative to that of the part-purified lithium containing solution. Lithium is the least rejected ion or salt of the second purification step.

In one form, the first and second purification steps may comprise one or more stages, passes or repeats of contact or exposure between the lithium containing solution passed to them and to the adsorbent or filter medium, respectively.

The Applicants have found that the graphene based filter medium works most effectively if presented with a relatively dilute lithium containing solution, as opposed to being presented with what may be termed a ‘raw’ brine. Such a raw brine is typically near saturated with sodium chloride. The part-purified lithium containing solution from the first purification step has been determined by the Applicants to be an appropriate if not ideal feed to the second purification step and is such that the graphene based filter medium may operate effectively to provide the further purified lithium containing solution of the present invention.

The present invention further provides a process for the synthesis of a titanate adsorbent. The titanate adsorbent is provided in the form of sodium titanate (Na₂Ti₃O₇) and hydrogen titanate (H₂TiO₃).

The titanate adsorbent formed in accordance with this process is suitable for the extraction of lithium from a lithium containing solution. The lithium containing solution may be a brine. The brine may contain impurities from the group of sodium, potassium, magnesium, calcium and borate.

The combined processing method for the purification of lithium containing solutions of the present invention may be further understood with reference to the following non-limiting examples.

### EXAMPLE 1

### Synthesis of Na₂Ti₃O₇ Nano-Tubes/Fibres

150 g of TiO₂ (Anatase type) powder was mixed with 3L NaOH solution (10 mol/L), and kept stirring for 2 hours, then transferred to 5L autoclave and react at each of 120° C., 150° C., and 180° C. for 48 h. Resulting Na₂Ti₃O₇ nano-tubes were washed using vacuum filtration until pH of filtrate was 7. The product weight after drying at 100° C. was 175 g. This produced high purity Na₂Ti₃O₇ nanotubes (over 95% product are tubes); the nanotubes have the largest specific surface area of 232 m²/g.

The sodium titanate was characterized by powder X-ray diffraction (XRD) and transmission electron microscopy (TEM) to confirm the morphological phase and structure.

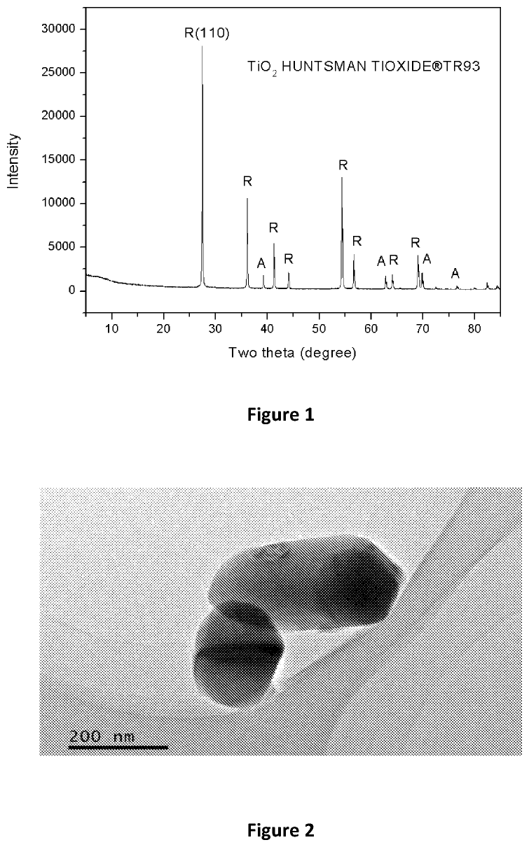

In FIG. 1 there is shown the XRD pattern of the pristine TiO2 powder. This suggests that TiO2 material contained mainly rutile (R) TiO2 mixed with some anatase (A) phase.

In FIG. 2 there is shown a TEM image of pristine TiO₂ is shown. It can be seen that the diameter of the TiO₂ particles is around 100˜200 nm.

Synthesis and XRD—Na₂Ti₃O₇ (Sodium Titanate)

The XRD patterns of the Na-titanate exhibit apparent difference from the pristine TiO₂ powder. The XRD patterns of these samples are in good agreement with that of monoclinic Na₂Ti₃O₇ phase. The synthetic processes and XRD patterns of Na₂Ti₃O₇ samples prepared at different temperatures 120° C., 150° C. and 180° C. are provided below.

Synthesis of Na₂Ti₃O_{7 a}t 120° C.

150 g TiO₂ powder was mixed with 3L NaOH solution (10 mol/L), and kept stirring for 2 h, then transferred to 5L autoclave and react at 120° C. for 48 h. Resulting Na₂Ti₃O₇ nanotubes were washed with water using vacuum filtration until pH value of filtrate was 7. Product weight after drying at 100° C.: 175 g.

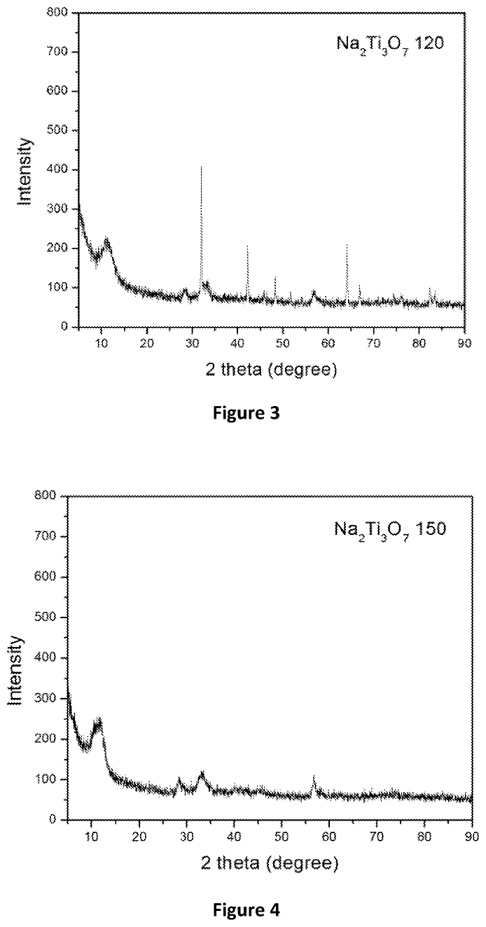

The XRD Pattern of Na₂Ti₃O₇ Prepared at 120° C. is shown in FIG. 3.

Synthesis of Na₂Ti₃O₇ at 150° C.

150 g TiO₂ powder mixed with 3 L NaOH solution (10 mol/L), and kept stirring for 2 h, then transferred to 5 L autoclave and react at 150° C. for 48 h. Resulting Na₂Ti₃O₇ nanotubes were washed with water using vacuum filtration until pH value of filtrate was 7. Product weight after drying: 171 g.

The XRD Pattern of Na₂Ti₃O₇ Prepared at 1500 C is shown in FIG. 4.

Synthesis of Na₂Ti₃O₇ at 180° C.

150 g TiO₂ powder mixed with 3 L NaOH solution (10 mol/L), and kept stirring for 2 h, then transferred to 5 L autoclave and react at 180° C. for 48 h. Resulting Na₂Ti₃O₇ nanotubes were washed with water using vacuum filtration until pH value of filtrate was 7. Product weight after drying: 172 g.

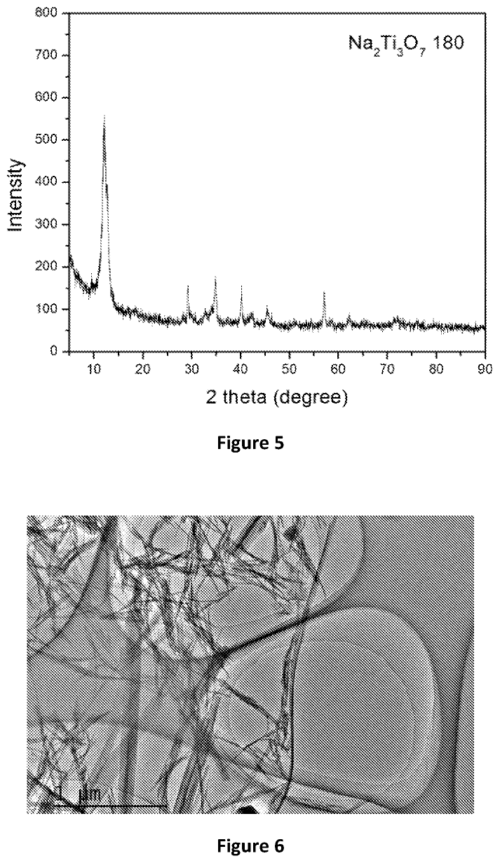

The XRD Pattern of Na₂Ti₃O₇ Prepared at 1800 C is shown in FIG. 5.

TEM: Na₂Ti₃O₇

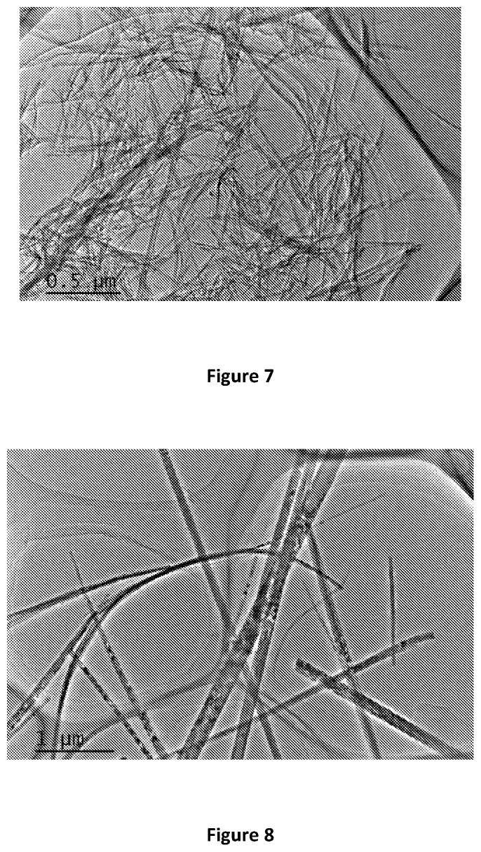

After the hydrothermal reaction, the TiO₂ particle morphology is changed. As can be seen clearly from the TEM images of the hydrothermal reaction products, the long tubes are well crystallized of layered Na-titanate according to the TEM images of the samples. A TEM image of Na₂Ti₃O₇ Prepared at 120° C. is shown in FIG. 6. A TEM image of Na₂Ti₃O₇ Prepared at 150° C. is shown in FIG. 7. A TEM image of Na₂Ti₃O₇ Prepared at 180° C. is shown in FIG. 8.

Synthesis of H₂TiO₃ Nano-Tubes/Fibres

### EXAMPLE 2

150 g of TiO₂ (Anatase type) and 13.9 g of Li₂CO₃ were mixed, ground and heated in an alumina crucible at a rate of ca 6° C./min in air up to 700° C. and maintained for the next 4 h. After cooling to room temperature, the solid powder (Li₂TiO₃) was treated with 0.2M HCl solution with occasional shaking for 24 h at room temperature (5 g solid in 1L HCl acid). The solid was separated by filtration, washed and deionized water until the filtrate was neutral, and allowed to dry at room temperature to obtain high purity H₂TiO_{3.}

### EXAMPLE 3

Anatase type TiO₂ (15.0 g, Ti 0.187 mole) and Li₂CO₃ (13.9 g, Li 0.376 mole) were mixed, ground and heated in an alumina crucible at a rate of ca. 6° C./min in air up to 700° C. and maintained for the next 4 h. After cooling to room temperature, the solid powder (Li2TiO₃) was treated with 0.2 M HCl solution with occasional shaking for 24 h at room temperature (5 g of solid in 1L acid). The solid was separated by filtration, washed with deionized water until the filtrate was neutral and allowed to dry at room temperature to obtain the H₂TiO_{3.}

The precursor (Li₂TiO₃) and (H₂TiO₃) sorbent was prepared through solid calcination method. XRD patterns of precursor and H₂TiO₃ sorbent matches the known literature.

TEM analysis indicates that H₂TiO₃ sorbent is mostly round shape nanoparticles and nano-rods with average size 200-400 nm. Li₂TiO₃ precursor exhibits similar structure as H₂TiO₃ sorbent suggesting that acid treatment has negligible impact on the morphology of the sorbent.

The surface area of synthesized H₂TiO₃ sorbent at 20.0 m²/g is far less than Na₂Ti₃O₇ nanotubes synthesized at 150° C. (232 m²/g). The Brunauer-Emmett-Teller (BET) result is consistent with TEM analysis.

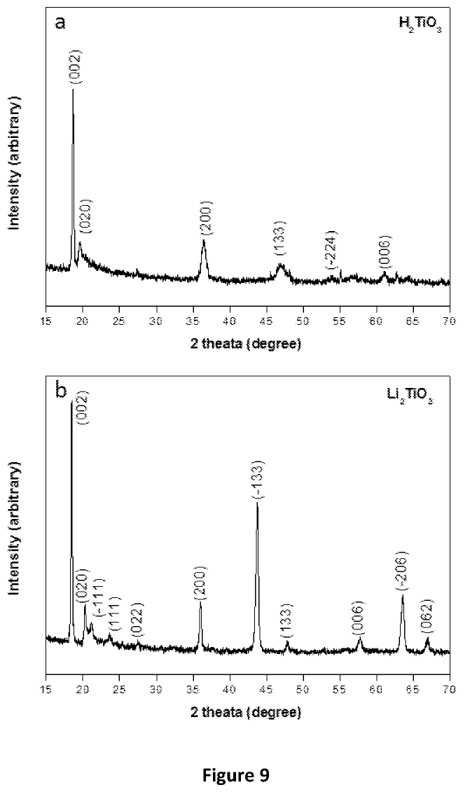

The XRD Patterns of Li₂TiO₃ and H₂TiO₃ are shown in FIG. 9.
TEM: Li₂TiO₃

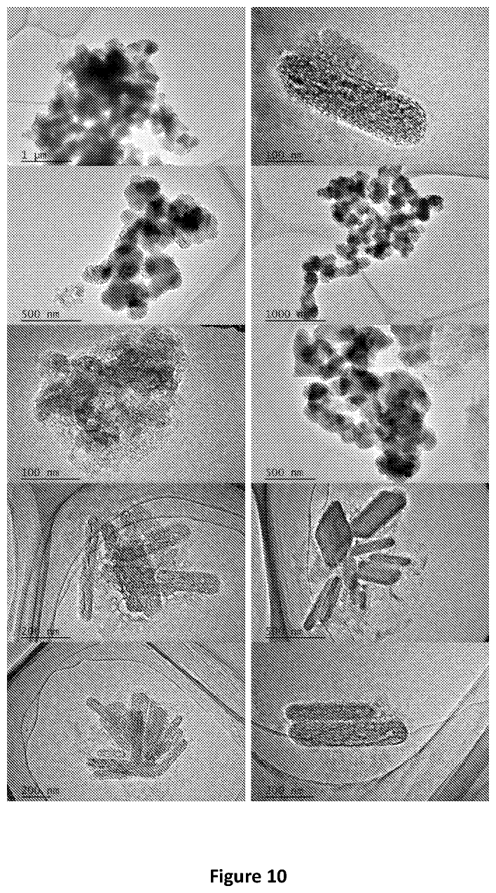

A TEM image of Li₂TiO₃ is shown at FIG. 10.
TEM: H₂TiO₃

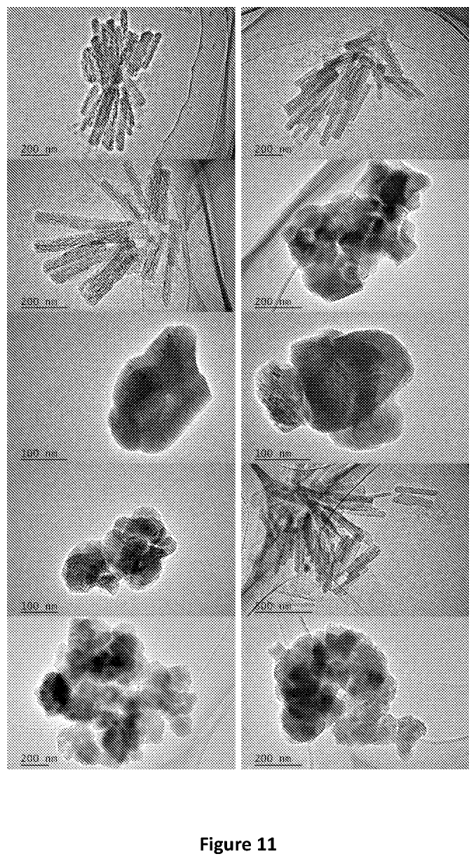

A TEM image of H₂TiO₃ is shown at FIG. 11.

### EXAMPLE 4

### Sorbent Tests

A brine solution, the composition of which is described in the table below (-j 300 ppm Li), was chosen for the adsorption tests.

TABLE 1
Composition of brine/L:

| Compound | Mass (g) |
|---|---|
| Na₂SO₄ | 23.53 |
| Na₂B₄O₇•10H₂O | 3.81 |
| NaHCO₃ | 0.32 |
| NaCl | 210.43 |
| KCl | 22.50 |
| MgCl₂•6H₂O | 40.80 |
| CaCl₂ | 1.25 |
| LiCl | 1.92 |

Sodium Titanate (Na₂Ti₃O₇) Sorbent Behaviour

The kinetics of lithium adsorption by sodium titanate was determined by sampling the brine during adsorption at time intervals of 5 min, 15 min, 30 min, 1 hr, 2 hr, 3 hr, 4 hr, 5 hr, 6 hr, 7 hr, 8 hr, 9 hr, 10 hr, 11 hr, 12 hr, 24 hr (16 sampling times). The adsorption kinetics for all 9 sodium titanate sorbents was determined using brine solution of similar composition and no buffer. Analytical characterisation was done by ICP, XRD and BET methods on selected samples.

It was observed that the Li⁺ adsorption reached to its equilibrium in 5-15 minutes for most of the adsorption test.

XRD characterisation of the adsorbed sorbent confirmed that the structure remains unchanged, however weak characterization peaks of MgTiOₓ (x=3 or 5) were observed because of heavy presence of Mg in the brine and affinity of sorbent towards Mg.

It was also observed that after Li⁺ uptake, the specific surface area of Na₂Ti₃O₇ decreases. Several observations and conclusions have also been made, including that Na₂Ti₃O₇ synthesized at 150° C. shows the highest Li⁺ uptake (1.42±0.1 mg/g) compared to the Na₂Ti₃O₇ synthesized at 120° C. and 180° C., when a Brine solution of 300 ppm Li⁺ concentration is used. Further, after Li⁺ uptake, very small nanoparticles (2-3 nm) were found on the surface of sodium titanate sorbents as indicated in TEM images. The XRD analysis show that those nanoparticles are mostly MgTiOₓ (x=3 or 5), this is thought to be due to the high concentration of Mg²⁺ (about 5000 ppm) in the brine solution.

XRD Pattern of Na₂Ti₃O₇ (Synthesised at 120° C.) After Adsorption Test

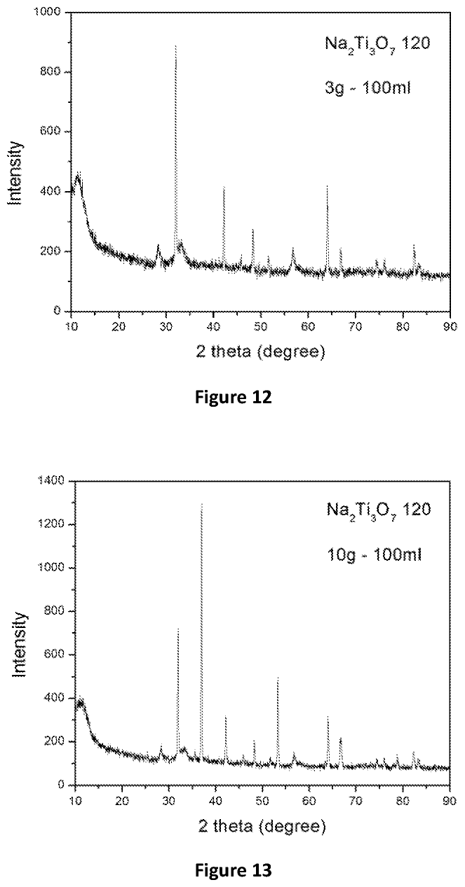

The Li brine (˜300 ppm Li) 100 mL was adsorbed for 2 h in 3 g sorbent. The XRD pattern is shown in FIG. 12.

The Li brine (˜300 ppm Li) 100 mL was adsorbed for 2 h in 10 g sorbent also. The XRD pattern is shown in FIG. 13.

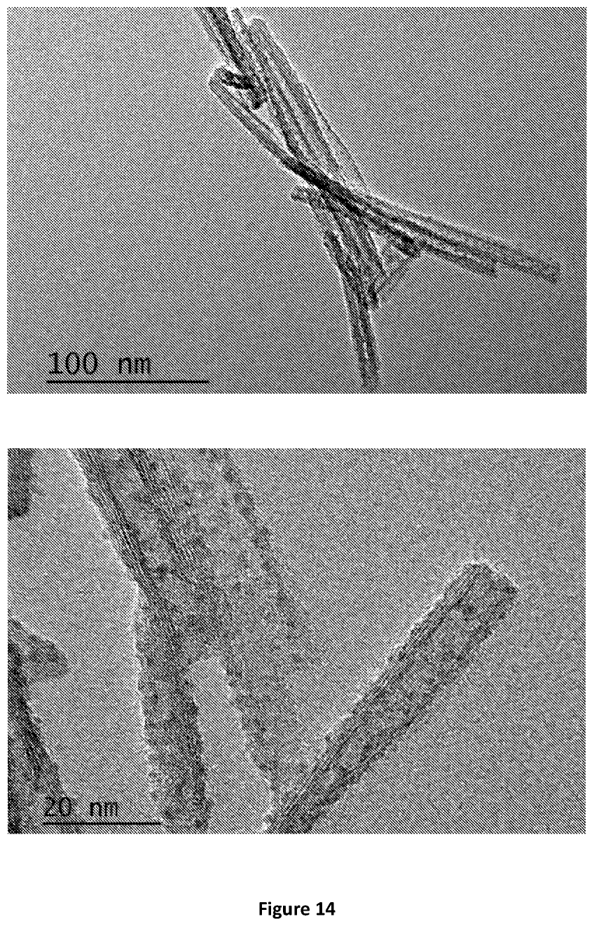

The TEM images of Na₂Ti₃O₇ (synthesised at 120° C.) collected after adsorption test in 100 mL of brine (˜300 ppm Li) for 2 h in 3 g sorbent are shown in FIG. 14.

XRD Pattern of Na₂Ti₃O₇ (Synthesised at 150° C.) After Adsorption Test

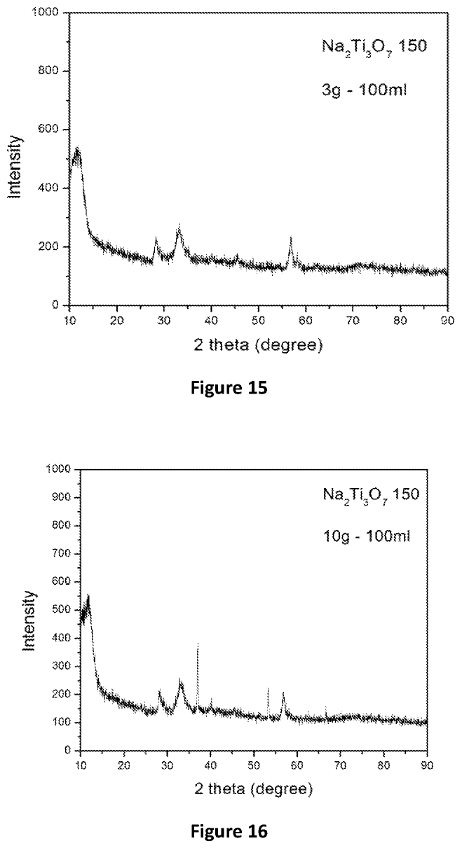

The Li brine (˜300 ppm Li) 100 mL was adsorbed for 2 h in 3 g sorbent. The XRD pattern is shown in FIG. 15.

The Li brine (˜300 ppm Li) 100 mL was adsorbed for 2 h in 10 g sorbent. The XRD pattern is shown in FIG. 16.

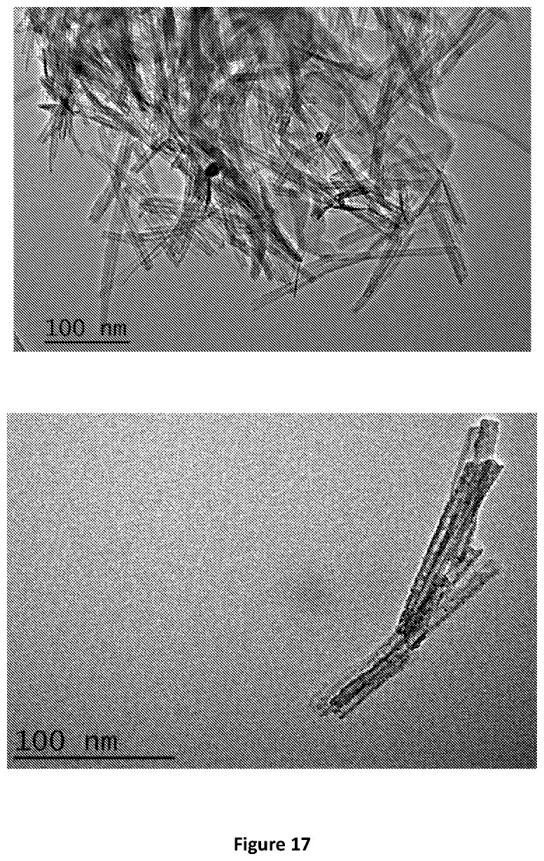

The TEM images of Na₂Ti₃O₇ (synthesised at 150° C.) collected after adsorption test in 100 mL of brine (˜300 ppm Li) for 2 h in 3 g sorbent is provided in FIG. 17.

XRD Pattern of Na₂Ti₃O₇ (Synthesised at 180° C.) after Adsorption Test

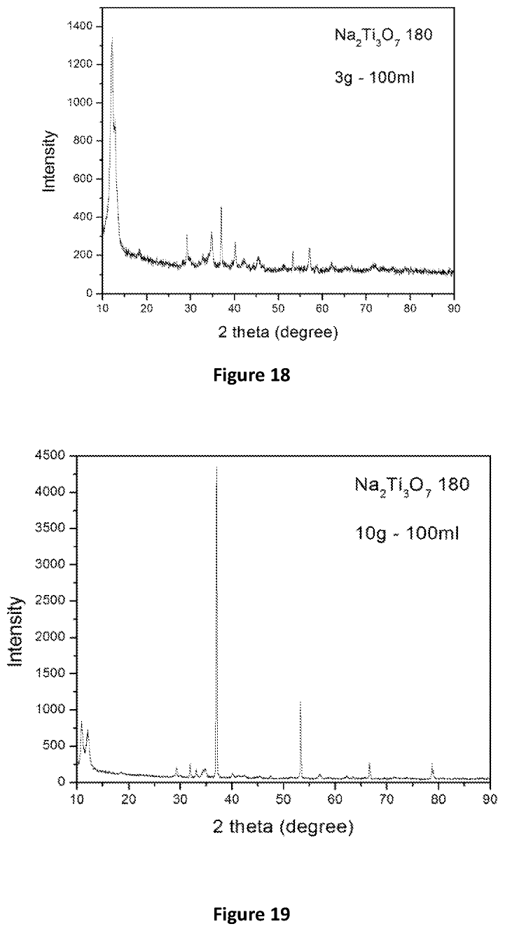

The Li brine (˜300 ppm Li) 100 mL was adsorbed for 2 h in 3 g sorbent. The XRD pattern is shown in FIG. 18.

The Li brine (˜300 ppm Li) 100 mL was adsorbed for 2 h in 10 g sorbent. The XRD pattern is shown in FIG. 19.

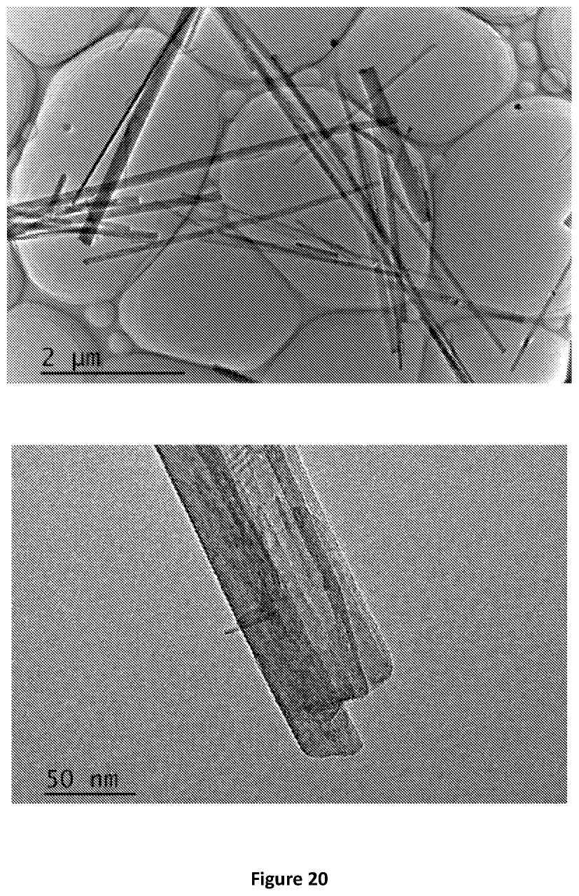

The TEM images of Na₂Ti₃O₇ (synthesised at 180° C.) collected after adsorption test in 100 mL of brine (˜300 ppm Li) for 2 h in 3 g sorbent are shown in FIG. 20.

ICP analysis results of sorption tests in for 3 g and 10 g sodium titanate sorbent in 100 ml brine solution (˜300 ppm Li+) after 2h are provided in the below table.

TABLE 2

| Brine (~300 ppm Li) | | Uptake (mg/g) | |
|---|---|---|---|
| Adsorbent | Sorbent (g)-Solution (ml) | Li | Mg |
| Na₂Ti₃O₇ (120° C.) | 3 g-100 ml | 0.68 | 4.43 |
| | 10 g-100 ml | 0.73 | 7.52 |
| Na₂Ti₃O₇ (150° C.) | 3 g-100 ml | 1.42 ± 0.1 | 5.61 |
| | 10 g-100 ml | 1.30 ± 0.1 | 6.27 |
| Na₂Ti₃O₇ (180° C.) | 3 g-100 ml | 0.41 | 1.2 |
| | 10 g-100 ml | 0.51 | 4.61 |

Na₂Ti₃O₇ (150° C.) shows the best results on Li uptake at 1.42 mg/g of sorbent in 100 mL brine solution adsorbed for 2 hours.

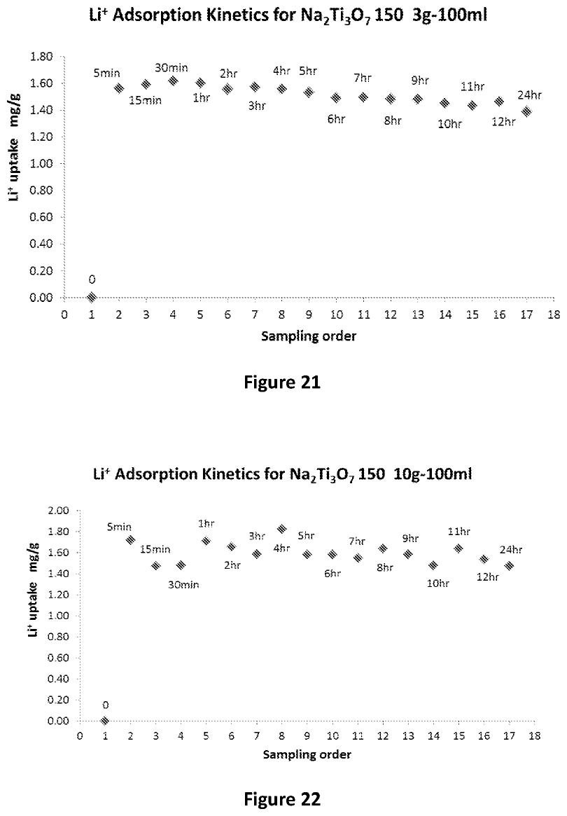

The Kinetic adsorption tests of sodium titanate Na₂Ti₃O₇ sorbent synthesizes at 150° C. in 100 ml brine solution (˜300 ppm Li) are shown in FIGS. 21 and 22 confirming that the Li⁺ adsorption reaches to its equilibrium in 5-15 minutes for most of the adsorption tests.

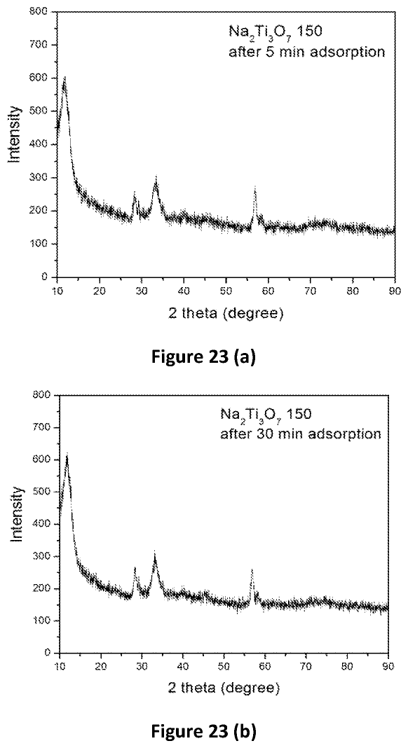

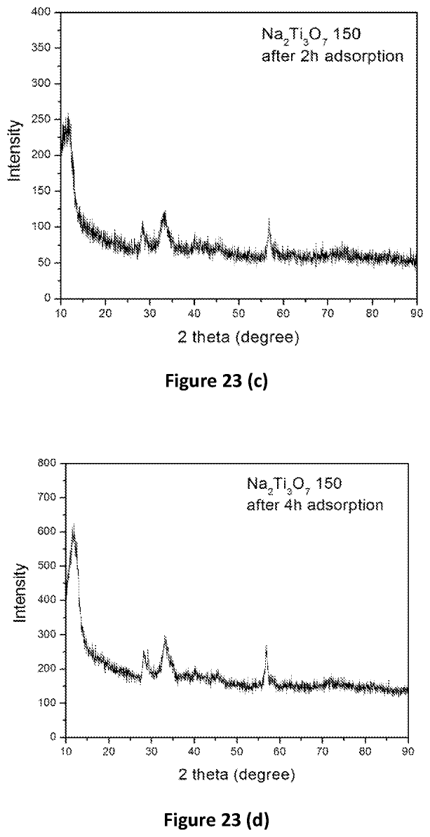

The XRD characterisation for sodium titanate (Na₂Ti₃O₇) synthesised at 150° C. sorbents was observed at 4 of the sampling times, and shown in FIGS. 23(a) to (d). It was observed that the structure of sorbent remains unchanged.

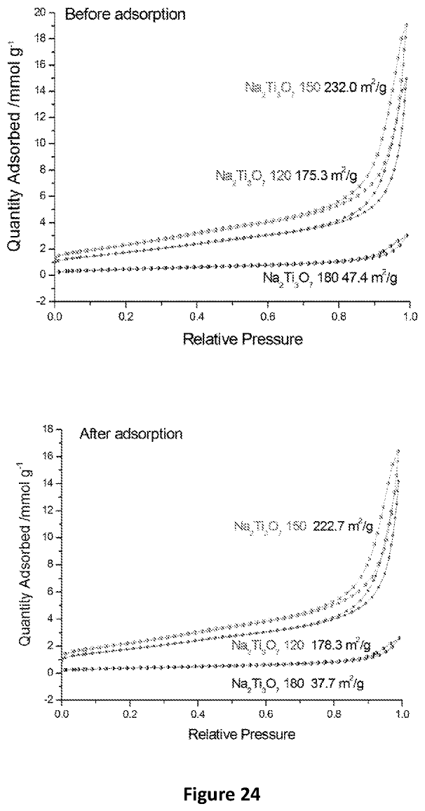

BET surface areas of sodium titanate synthesizes at 120° C., 150° C. and 180° C. were observed before and after adsorption and are shown in FIG. 24.

With the exception of sodium titanate synthesised at 120° C. which nearly remains unchanged within the experimental error variation, all other sodium titanate samples showed decrease in BET surface area after adsorption.

Li equilibrium adsorption for sodium titanate sorbents for different concentration of Li in brine was also studied. It was found that Na₂Ti₃O₇ sorbent synthesized at 150° C. reaches the Li⁺ uptake equilibrium of 4.65 mg/g at Li⁺ concentration above 1,300 ppm when dispersed 3 g sorbent into 100 ml brine solution. An increase in the sorbent amount to 10 g, the uptake equilibrium was found to decrease to 2.5 mg/g.

Na₂Ti₃O_{7 120} and Na₂Ti₃O₇ 180 show much lower Li⁺ uptake equilibrium below 1.5 mg/g at those concentrations of Li in brine.

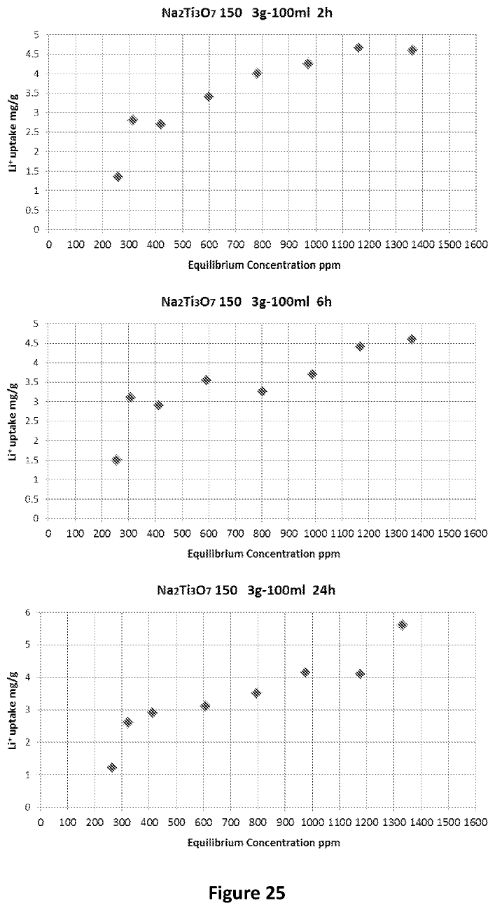

The kinetics of 3g sodium titanate sorbent prepared at 150° C. (Na₂Ti₃O_{7 150}) for 100 mL brine solution with different concentrations of Li⁺ ions and at different times of adsorption is shown in FIG. 25. The maximum adsorption at 4.65 mg/g of sorbent may be achieved in 2 hours at 1,300 ppm Li concentration in brine.

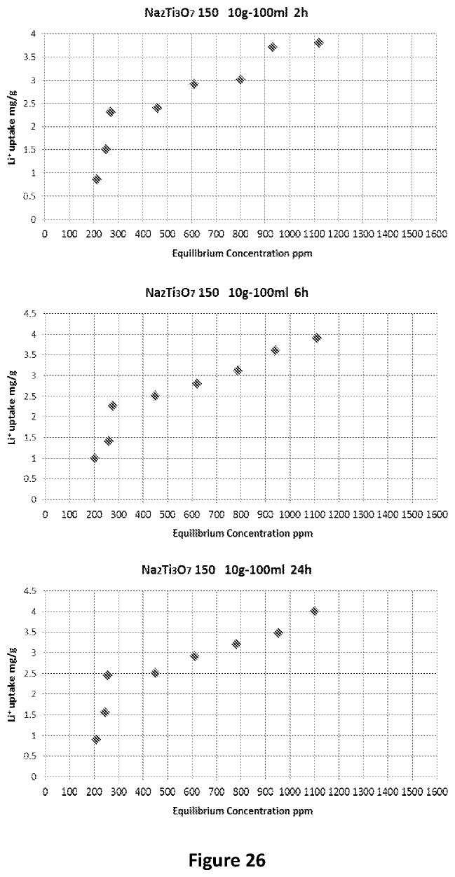

The kinetics of 10 g sodium titanate sorbent prepared at 150° C. (Na₂Ti₃O_{7 150}) for 100 mL brine solution with different concentrations of Li⁺ ions and at different times of adsorption is shown in FIG. 26. The adsorption of Li at ˜4 mg/g of sorbent is lower than using 3 g of sorbent/100 mL of brine solution.

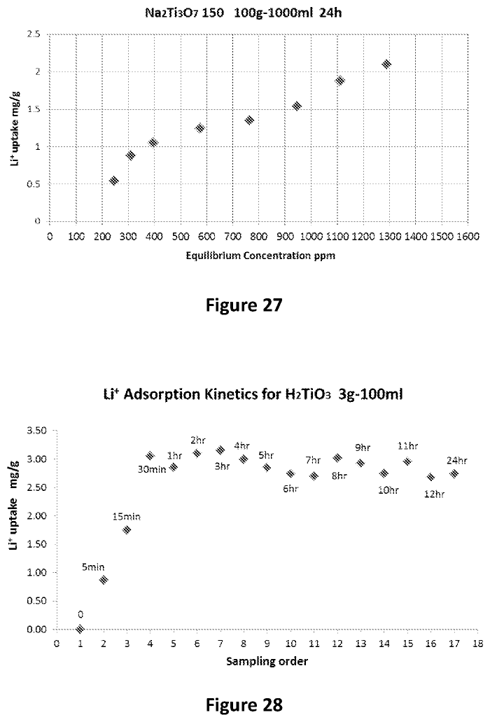

An increased in amount of sorbent to 100 g/100 mL of brine solution (sorbent prepared at 150° C.—Na₂Ti₃O_{7 150}) for different concentrations of Li⁺ ions and at different times of adsorption is shown in FIG. 27. The adsorption of Li decreases significantly.

Sorbent Behaviour of Hydrogen Titanate (H₂TiO₃)

Li adsorption kinetics for H₂TiO₃ sorbents was determined by sampling the brine during adsorption at time intervals of 5 min, 15 min, 30 min, 1 hr, 2 hr, 3 hr, 4 hr, 5 hr, 6 hr, 7 hr, 8 hr, 9 hr, 10 hr, 11 hr, 12 hr, 24 hr (16 sampling times). The adsorption kinetics for H₂TiO₃ sorbents was determined using just 300 ppm Li brine solution.

For analytical characterisation, ICP was performed for all samples. XRD characterisation was performed for half of the H₂TiO₃ sorbent at 4 of the sampling times. BET characterisation was performed for the H₂TiO₃ sorbent synthesised before and after Li⁺ adsorption.

It was observed that the Li⁺ adsorption reached to its equilibrium after 30 minutes for H₂TiO₃ sorbent, which was found to be slower than Na₂Ti₃O₇ nanotubes synthesized at 150° C.

XRD patterns of H₂TiO₃ after Li⁺ adsorption suggests that the impact of adsorption process on H₂TiO₃ sorbent is negligible.

After Li⁺ uptake, the specific surface area of H₂TiO₃ sorbent was found to be decreased from 20 m²/g to 18.1 m²/g.

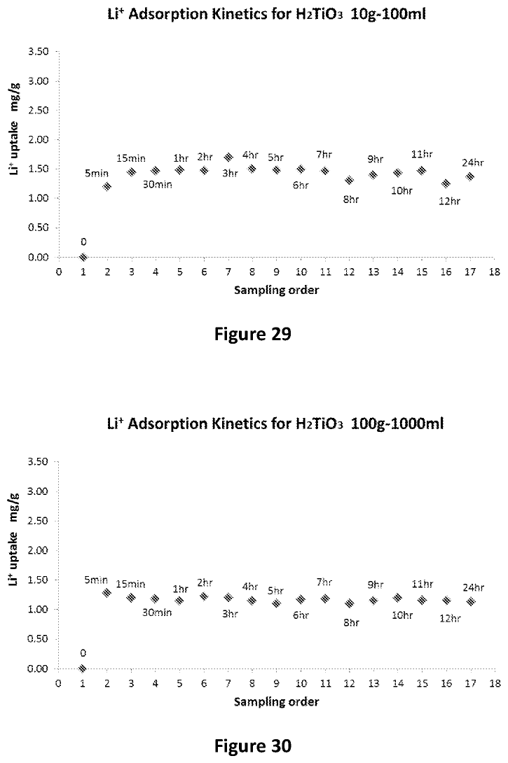

The FIGS. 28 to 30 show the results of the kinetic adsorption tests of hydrogen titanate sorbent (H₂TiO₃) in different sorbent to solution ratio: 3g-100mL, 10g-100mL, and 100g-1000mL brine solution (˜300 ppm Li), respectively.

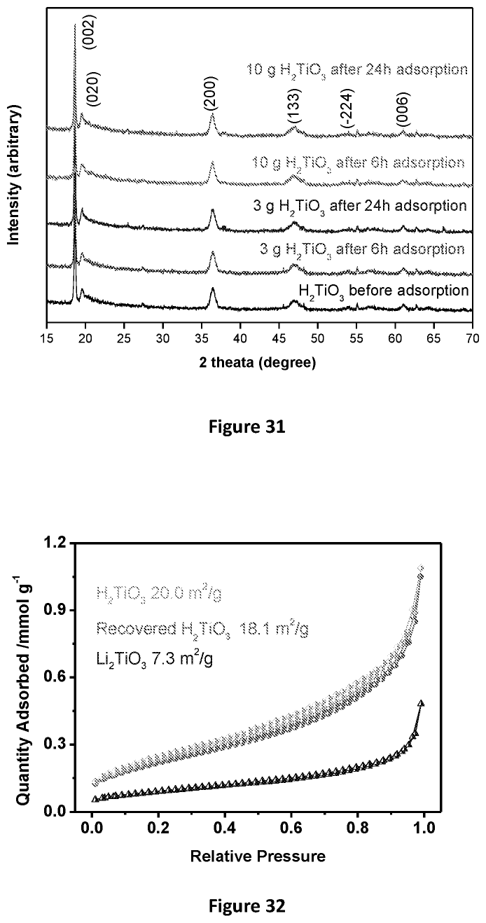

FIG. 31 shows XRD data of the sorbent hydrogen titanate sorbent (H₂TiO₃) before and after adsorption at different times.

FIG. 32 shows BET surface area data of the sorbent hydrogen titanate sorbent (H₂TiO₃) before and after adsorption.

The Li equilibrium adsorption for a hydrogen titanate sorbent was observed for different brine concentrations. ICP characterisation was performed for all the samples.

It was observed that H₂TiO₃ sorbent reaches the Li⁺ uptake equilibrium of 4.4 mg/g at Li⁺ concentration of 500 ppm when dispersed 3 g sorbent into 100 ml brine solution. Neither increasing nor decreasing Li⁺ concentration leads to reduced Li⁺ uptake capacity. Increase the sorbent amount to 10 g, the uptake equilibrium is decreased to 2.8 mg/g. The results suggest H₂TiO₃ sorbent exhibits better Li⁺ uptake at relatively low Li⁺ concentration (300-700 ppm) while Na₂Ti₃O₇-150 sorbent exhibits better performance at high Li⁺ concentration (900-1500 pm). When using large scale of sorbent 100 g H₂TiO₃ to large scale of brine solution (1000 ml), the sorption capacity is rather low up to 1.3 mg/g only.

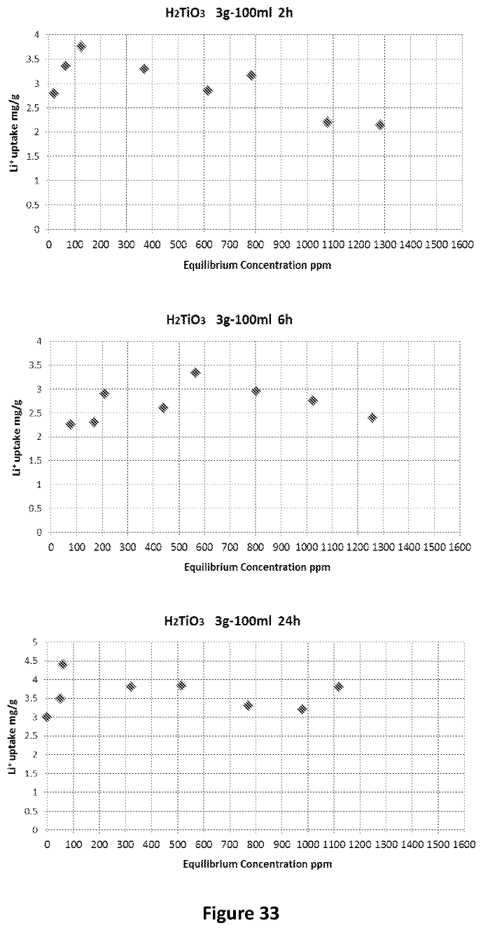

FIG. 33 shows the reaction kinetics of 3 g hydrogen titanate sorbent (H₂TiO₃), 100 mL brine solution with different concentrations of with different concentrations of Li⁺ ions.

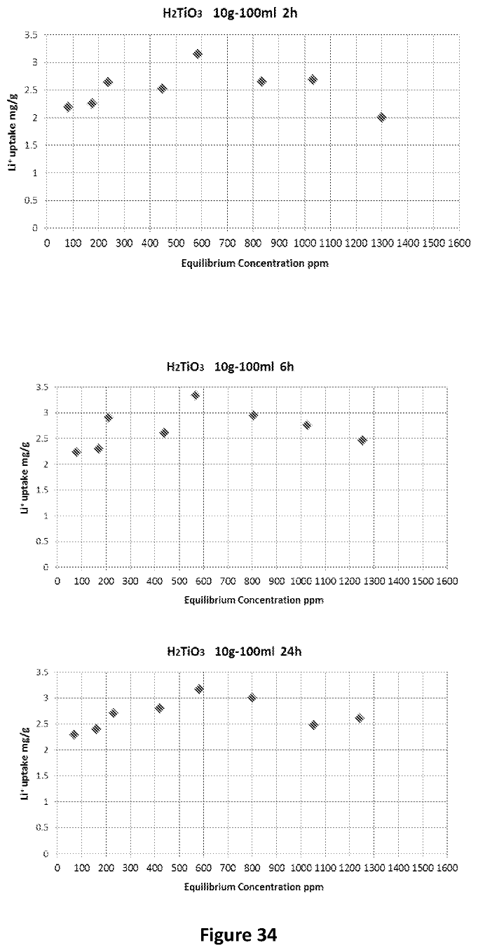

FIG. 34 shows the reaction kinetics of 10 g hydrogen titanate sorbent (H₂TiO₃), 100 mL brine solution with different concentrations of with different concentrations of Li⁺ ions.

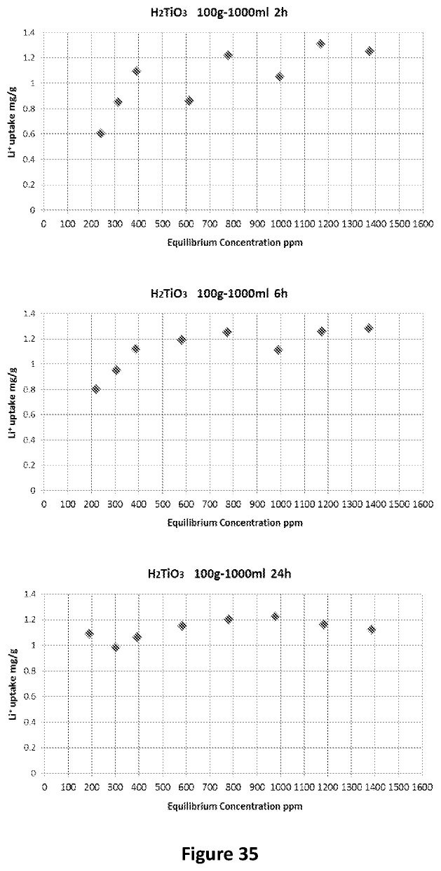

FIG. 35 shows the reaction kinetics of 100 g hydrogen titanate sorbent (H₂TiO₃), 1000 mL brine solution with different concentrations of with different concentrations of Li⁺ ions.

### EXAMPLE 5

### Recovery of Li/Regeneration of Sorbents

Recovery of Li/Regeneration of sorbents for different regeneration conditions (limited sorbent/brine combinations) was studied. The combination of the 4 titanate sorbents and 3 brine solutions were selected for assessment of Li recovery and sorbent regeneration. The hydrogen titanate sorbent with the same 2 brine solutions was also tested. All samples were tested under 0.05 M and 0.1 M HCl solution at 25° C. and 60° C. respectively. Regeneration kinetics were determined by sampling the solution at time intervals of 5 min, 15 min, 30 min, 1 h, 2 h, 3 h, 4 h, 5 h, 6 h, 7 h, 8 h, 9 h, 10 h, 11 h, 12 h, and 24 h.

Analytical characterisation was performed using ICP (inductively coupled plasma atomic emission spectroscopy), XRD (x-ray diffraction) and TEM (transmission electron microscopy).

The observations were that the Li⁺ recovery amount from sodium titanate synthesized at 150° C. sorbent was the highest at 1.4 mg/g during all samples used for this recovery test, which are below 1.0 mg/g. ICP data of Li⁺ recovery kinetic data indicates that, when using brine solution with the composition as above, the Li⁺ desorption reached equilibration at 5 mins for sodium titanate synthesized at 150° C. and 30 mins for H₂TiO₃ sorbent, respectively. The 0.1 M HCl solution exhibited superior desorption property compared with the diluted HCl solution (0.05 M) only except with H₂TiO₃ sorbent. The high desorption temperature (60° C.) can increase the Li+desorption equilibration compared with that of room temperature.

According to the XRD characterization, 0.05 M HCl has negligible impact on the crystal structure of titanate nanotube sorbents. However, the XRD patterns suggests that concentrated HCl solution (0.1 M) can convert the sodium titanate to hydrogen titanate and anatase TiO₂ phase. TEM images of 4 sorbents after desorption at 25° C. using 0.05 M HCl suggested the unchanged morphology of 4 sorbents.

EXAMPLE 6

### Kinetic Desorption Tests

Sodium Titanate Synthesized at 120° C. (TNT 120)

10 g of the adsorbed sorbent was dispersed in 100 ml recovery solutions of 0.05M HCl and 0.1M HCl, respectively. Two different desorption temperatures were applied to find the influence of temperature. The four groups of desorption data are plotted together for a clear comparison.

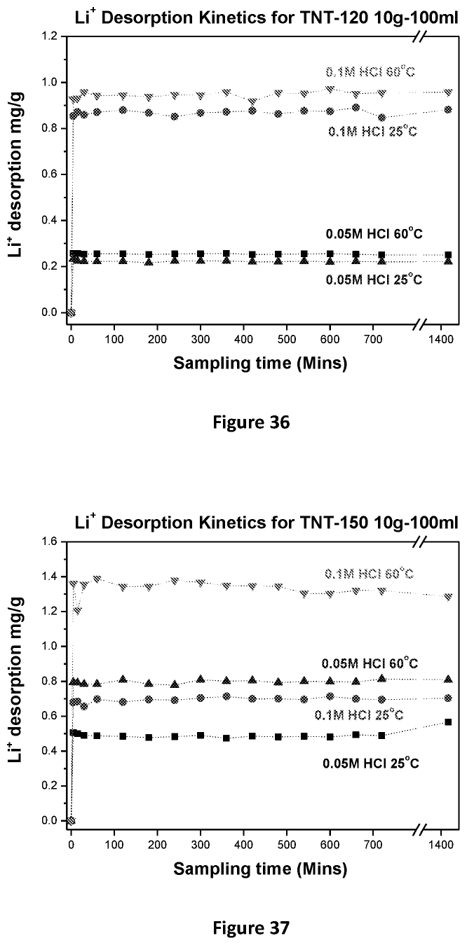

As shown in FIG. 36, the higher concentration of HCl recovery solution exhibited the higher recovery amount of Li⁺ from the used sodium titanate synthesized at 120° C. (TNT 120). The elevated desorption temperature (60° C.) is able to increase the Li⁺ recovery, but not significantly. The triangles are desorption data over time using 0.05 M HCl solution at 25° C. The squares are desorption data over time using 0.05 M HCl solution at 60° C. The diamonds are desorption data over time using 0.1 M HCl solution at 25° C. The inverted triangles are desorption data over time using 0.1 M HCl solution at 60° C.

Element desorption from TNT-120 sorbent after adsorption with 10 g sorbent after 24 h is provided in the table below.

TABLE 3

| | Desorption | Desorption | Element release (mg/L) | | | | | |
|---|---|---|---|---|---|---|---|---|
| Adsorbent | agent | temperature | Li | B | Ca | K | Mg | Na |
| TNT-120 | 0.05M | 25° C. | 0.25 | 0.14 | 0.03 | 0.56 | 0.02 | 11.7 |
| | HCl | | | | | | | |
| TNT-120 | 0.1M HCl | 25° C. | 0.88 | 0.17 | 5.49 | 5.73 | 2.43 | 39.7 |
| TNT-120 | 0.05M | 60° C. | 0.56 | 0.42 | 0.03 | 2.81 | 0.30 | 54.91 |
| | HCl | | | | | | | |
| TNT-120 | 0.1M HCl | 60° C. | 0.95 | 0.18 | 5.8 | 5.67 | 1.9 | 41.5 |

Sodium Titanate Synthesized at 150° C. (TNT 150)

10 g of the sorbent TNT 150 was dispersed in 100 ml recovery solutions of 0.05M HCl and 0.1 M HCl respectively. Two different desorption temperatures were applied. The four groups of desorption data are plotted together for a clear comparison.

The Li⁺ recovery amount from TNT-150 sorbent is the highest (1.4 mg/g) during all samples used for this recovery test.

At a same temperature, the higher concentration of HCl recovery solution exhibited the higher recovery amount of Li⁺ from the used TNT-150 sorbents, as shown in FIG. 37. The elevated desorption temperature (60° C.) is able to increase the Li⁺ recovery significantly, this is quite different from the other recovered samples. The triangles are desorption data over time using 0.05 M HCl solution at 25° C. The squares are desorption data over time using 0.05 M HCl solution at 60° C. The diamonds are desorption data over time using 0.1 M HCl solution at 25° C. The inverted triangles are desorption data over time using 0.1 M HCl solution at 60° C.

The following table depicts the element desorption from TNT-150 sorbent after adsorption brine solution with 10 g sorbent after 24 h.

TABLE 4

| | Desorption | Desorption | Element release (mg/L) | | | | | |
|---|---|---|---|---|---|---|---|---|
| Adsorbent | agent | temperature | Li | B | Ca | K | Mg | Na |
| TNT-150 | 0.05M | 25° C. | 0.488 | 0.37 | 0.03 | 2.6 | 0.22 | 48.59 |
| | HCl | | | | | | | |
| TNT-150 | 0.1M HCl | 25° C. | 0.7035 | 0.39 | 6.07 | 6.38 | 1.09 | 71.96 |
| TNT-150 | 0.05M | 60° C. | 0.81 | 0.38 | 0.26 | 7.04 | 0.86 | 75.87 |
| | HCl | | | | | | | |
| TNT-150 | 0.1M HCl | 60° C. | 1.29 | 0.38 | 0.27 | 3.01 | 1.01 | 75.76 |

Sodium Titanate Synthesized at 180° C. (TNT 180)

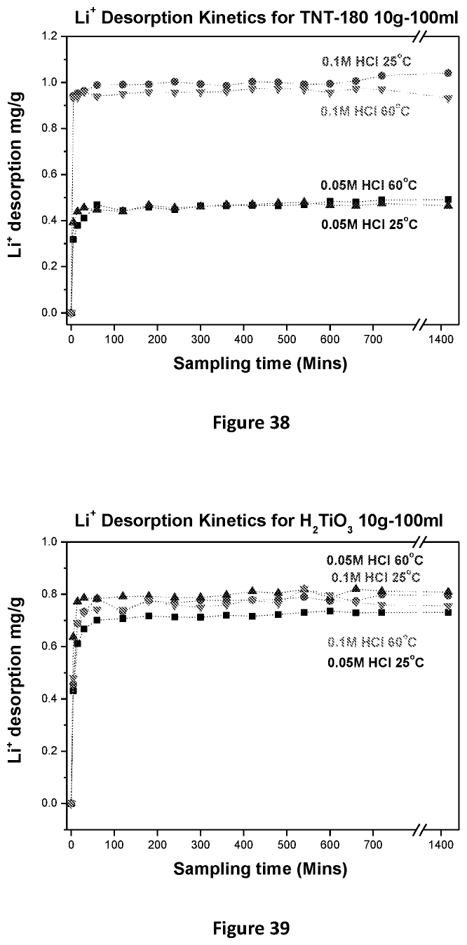

The collected sodium titanate sorbent TNT-180 after adsorption in brine solution, 10g dispersed in 100 ml recovery solutions of 0.05M HCl and 0.1M HCl, respectively. Two different desorption temperatures were applied. The four groups of desorption data are plotted together for a clear comparison and shown in FIG. 38.

The higher concentration of HCl recovery solution exhibited the higher recovery amount of Li⁺ from the used TNT-180 sorbents.

The elevated desorption temperature (60° C.) did not show a clear increase of Li⁺ recovery. The triangles are desorption data over time using 0.05 M HCl solution at 25° C. The squares are desorption data over time using 0.05 M HCl solution at 60° C. The diamonds are desorption data over time using 0.1 M HCl solution at 25° C. The inverted triangles are desorption data over time using 0.1 M HCl solution at 60° C.

The following table depicts the element desorption from TNT-180 sorbent after adsorption in brine solution with 10 g sorbent after 24 h.

TABLE 5

| | Desorption | Desorption | Element release (mg/L) | | | | | |
|---|---|---|---|---|---|---|---|---|
| Adsorbent | agent | temperature | Li | B | Ca | K | Mg | Na |
| TNT-180 | 0.05M | 25° C. | 0.3347 | 0.11 | 0.01 | 1.05 | 0.03 | 29.60 |
| | HCl | | | | | | | |
| TNT-180 | 0.1M HCl | 25° C. | 0.832 | 0.11 | 1.70 | 2.60 | 0.44 | 80.06 |
| TNT-180 | 0.05M | 60° C. | 0.4916 | 0.13 | 0.02 | 1.08 | 0.09 | 37.72 |
| | HCl | | | | | | | |
| TNT-180 | 0.1M HCl | 60° C. | 1.041 | 0.15 | 1.66 | 3.03 | 0.38 | 94.96 |

Hydrogen Titanate

The collected hydrogen titanate sorbent (H₂TiO₃) after adsorption in brine solution, 10 g sorbent was dispersed in 100 ml recovery solutions of 0.05M HCl and 0.1 M HCl, respectively. Two different desorption temperatures were applied. The four groups of desorption data are plotted together for a clear comparison, as shown in FIG. 39.

The different concentration of recovery solution or different recovery temperatures do not show a significant impact on the Li⁺ recovery as it shown to other sodium titanate samples. FIG. 39 shows kinetic desorption test of H₂TiO₄ sorbent after adsorption in brine solution. The triangles are desorption data over time using 0.05 M HCl solution at 25° C.; the squares are desorption data over time using 0.05 M HCl solution at 60° C.; the diamonds are desorption data over time using 0.1 M HCl solution at 25° C.; the inverted triangles are desorption data over time using 0.1 M HCl solution at 60° C.

The following table shows element desorption from H₂TiO₄ sorbent after adsorption in brine solution with 10 g sorbent after 24 h.

TABLE 6

| | Desorption | Desorption | Element release (mg/L) | | | | | |
|---|---|---|---|---|---|---|---|---|
| Adsorbent | agent | temperature | Li | B | Ca | K | Mg | Na |
| H₂TiO₃ | 0.05M | 25° C. | 0.731 | 0.004 | 0.05 | 0.10 | 0.016 | 1.90 |
| | HCl | | | | | | | |
| H₂TiO₃ | 0.1M HCl | 25° C. | 0.795 | 0.01 | 0.08 | 0.14 | 0..03 | 2.50 |
| H₂TiO₃ | 0.05M | 60° C. | 0.8085 | 0.006 | 0.07 | 0.20 | 0.03 | 2.28 |
| | HCl | | | | | | | |
| H₂TiO₃ | 0.1M HCl | 60° C. | 0.7554 | 0.02 | 0.10 | 0.23 | 0.10 | 2.03 |

### XRD Analysis

The XRD patterns suggested that concentrated HCl solution (0.1 M) can convert the sodium titanate TNT-120 and TNT-150 to hydrogen titanate and anatase TiO₂ phase slightly. TNT-180 has a more significant phase transformation, probably not feasible for repeated use. The possible impact of this slight phase change of sorbent in HCl solution to the next cycle Li⁺ uptake and recovery may explored in the future study.

### XRD of TNT-120 After Li Recovery

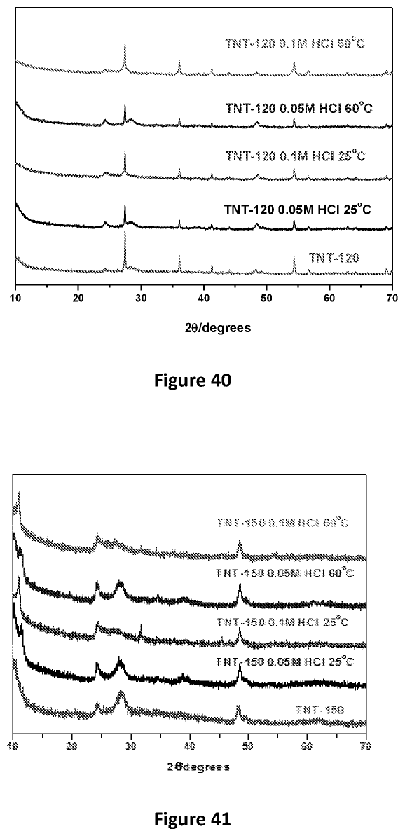

FIG. 40 shows XRD patterns of TNT-120 sorbent after adsorption in 300 ppm Li⁺ solution. From the bottom, the first line is original TNT-120. The second line is TNT-120 after desorption using 0.05 M HCl solution at 25° C. The third line is TNT-120 after desorption using 0.1 M HCl solution at 25° C. The fourth line is TNT-120 after desorption using 0.05 M HCl solution at 60° C. The top line TNT-120 after desorption using 0.1 M HCl solution at 60° C.

### XRD of TNT-150 After Li Recovery

FIG. 41 shows the XRD patterns of TNT-150 sorbent after adsorption in 300 ppm Li⁺ solution. Reading from the bottom, the first line is original TNT-150. The second line is TNT-150 after desorption using 0.05 M HCl solution at 25° C. The third line is TNT-150 after desorption using 0.1 M HCl solution at 25° C. The fourth line is TNT-150 after desorption using 0.05 M HCl solution at 60° C. The top line TNT-150 after desorption using 0.1 M HCl solution at 60° C.

### XRD of TNT-180 After Li Recovery

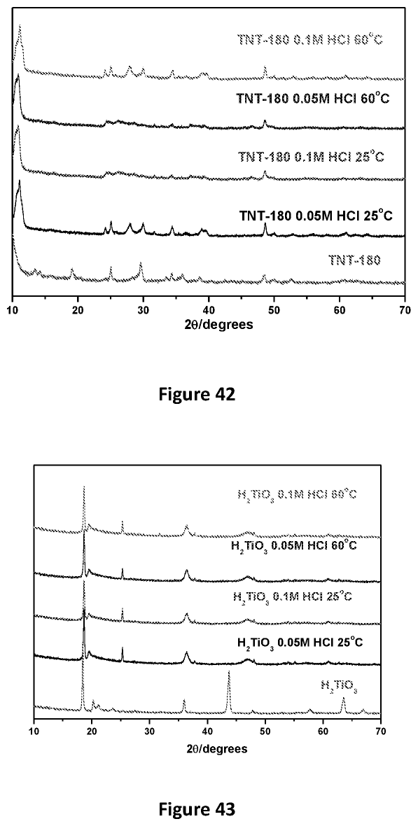

FIG. 42 shows the XRD patterns of TNT-180 sorbent after adsorption in 300 ppm Li⁺ solution. Reading from the bottom, the first line is the original TNT-180. The second line is TNT-180 after desorption using 0.05 M HCl solution at 25° C. The third line is TNT-180 after desorption using 0.1 M HCl solution at 25° C. The fourth line is TNT-180 after desorption using 0.05 M HCl solution at 60° C. The top line is TNT-180 after desorption using 0.1 M HCl solution at 60° C.

XRD of H₂TiO₃ After Li Recovery

FIG. 43 shows the XRD patterns of H₂TiO₃ sorbent after adsorption in 300 ppm Li⁺ solution. Reading from the bottom up, the first line is the original H₂TiO_{3.} The second line is H₂TiO₃ after desorption using 0.05 M HCl solution at 25° C. The third line is H₂TiO₃ after desorption using 0.1 M HCl solution at 25° C. The fourth line is H₂TiO₃ after desorption using 0.05 M HCl solution at 60° C. The fifth line is H₂TiO₃ after desorption using 0.1 M HCl solution at 60° C.

### EXAMPLE 7

### TEM Analysis

TEM images of Desorbed TNT-120

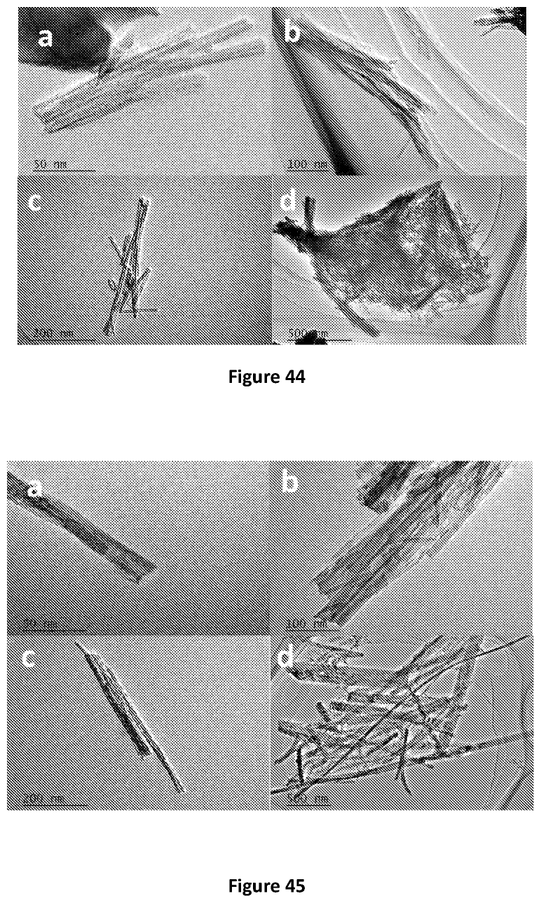

TEM images of TNT-120 sorbents after desorption with 0.05M HCl at 25° C. are shown in FIG. 44. The comparison of sorbent morphology before and after desorption indicates that the Li⁺ recovery process does not show significant impact on the nanofiber. TEM images of TNT-120 sorbent after desorption with 0.05M HCl at 25° C. under different resolution (a) 50 nm, (b) 100 nm, (c) 200 nm, (d) 500 nm are shown.

### TEM Images of Desorbed TNT-150

EM images of TNT-150 sorbents after desorption with 0.05M HCl at 25° C. are shown in FIG. 45. The comparison of sorbent morphology before and after desorption indicates that the Li⁺ recovery process does not show significant impact on the nanofiber. TEM images of TNT-150 sorbent after desorption with 0.05M HCl at 25° C. under different resolution (a) 50 nm, (b) 100 nm, (c) 200 nm, (d) 500 nm are shown.

### TEM Images of Desorbed TNT-180

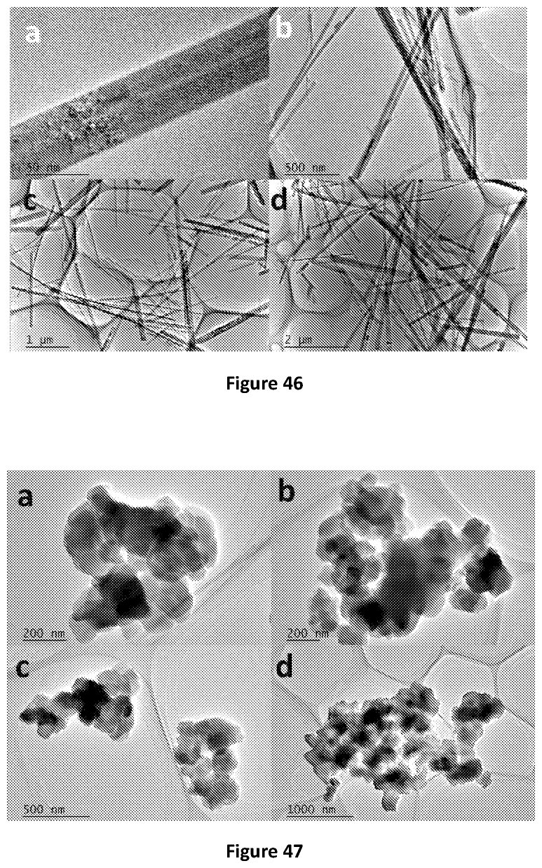

The TEM images of TNT-180 sorbents after desorption with 0.05M HCl at 25° C. are shown in FIG. 46. The TNT-180 nanotubes are relatively large than TNT-120 and TNT-150, therefore low resolution. The comparison of sorbent morphology before and after desorption indicates that the Li⁺ recovery process does not show significant impact on the nanofiber. TEM images of TNT-180 sorbent after desorption with 0.05M HCl at 25° C. under different resolution (a) 50 nm, (b) 500 nm, (c) 1000 nm, (d) 2000 nm are shown.

TEM Images of H₂TiO₃

The TEM images of H₂TiO₃ sorbents after desorption with 0.05M HCl at 25° C. are shown in FIG. 47. The H₂TiO₃ sorbents are still particle aggregations over 100 nm, therefore. TEM images above 200 nm are collected as shown in the following figure. The comparison of sorbent morphology before and after desorption indicates that the Li⁺ recovery process removed the hand-shape particles from original sorbent. It is inferred that the hand-shape particles are Li2CO₃ that dissolved by HCl solution, the amorphous particles aggregations, on the other hand, are H₂TiO₃ nanoparticles and their morphology is not influenced by desorption processes. TEM images of TNT-180 sorbent after desorption with 0.05M HCl at 25° C. under different resolution (a) and (b) 200 nm, (c) 500 nm, (d) 1000 nm is shown.

### EXAMPLE 8

### Brine Treatment With Adsorbents

Both sodium titanate (Na₂Ti₃O₇) and hydrogen titanate (H₂TiO₃) are, as noted above, preferred forms of the adsorbents used in the process of the present invention. Suitable sodium titanate (Na₂Ti₃O₇) and/or hydrogen titanate (H₂TiO₃) were synthesised as per methods described above. The function of the adsorbent material in the process of the present invention, without being limited by theory, is to absorb lithium ions from the LiCl brine and thereby rejecting the impurities, including competing cations.

The adsorbent (Na₂Ti₃O₇ and/or H₂TiO₃) used in this embodiment of the present invention may advantageously be placed in a series of column. Further, the adsorbent may be placed in a series of columns and the brine solution may be directed through this series of columns. In other preferred embodiments the adsorbent columns may be placed before the brine solution.

The lithium containing brine with the composition stated above was placed in a beaker. The adsorbent (Na₂Ti₃O₇ or H₂TiO₃) was packed in a series of vertical columns. The amount of adsorbent top pack in the series of columns to treat a particular brine was selected to adsorb maximum Li from the brine in provided series of columns as per data obtained from our R&D and stated above.

The brine was passed through the series of vertical columns and retained for 5 minutes to several hours for complete adsorption of lithium in the adsorbent packed columns. After this, the lithium adsorbed in the adsorbent was stripped from the adsorbent using a dilute HCl acid the optimum strength as discussed and provided above. The stripped solution was analysed for the concentration of Li and all other impurities such as B, Na, K, Ca and Mg. The lithium was found to be extracted at >90% from the brine.

The following table shows the comparative analyses of the original brine solution before feeding to the adsorbents and after desorbed from the adsorbents.

TABLE 7

| | Original Brine | Desorbed Brine ppm | Desorbed Brine |
|---|---|---|---|
| Elements | ppm | Na₂Ti₃O₇ (TNT 150) | ppm H₂TiO₃ |
| Li | 316 | 294 | 290 |
| B | 432 | 87 | 2.3 |
| Ca | 410 | 62 | 26 |
| K | 12,000 | 686 | 72 |
| Mg | 5,000 | 230 | 2 |
| Na | 100,000 | 17,266 | 820 |

An appropriate apparatus to be used in carrying out the first purification step of the present invention may be any manifold system whereby a lithium containing brine can be delivered to a series of columns containing an adsorbent and then ultimately collected in a receiving vessel. The apparatus may also have a means for drawing aliquots of LiCl for analysis. Such means may be a sample port comprising a resilient septum affixed in line to the apparatus. The apparatus may be composed of several vessels such as glass flasks, ceramic containers, metal containers or other typical non-reactive chemical reaction vessels. The vessels may be connected using non-reactive polymeric tubing, metal pipe or tube, or glass pipe or tube. The apparatus may be sectioned off using any type of valve stopcock or clamp depending on the composition of the tubing or piping.

The combined processing method for the purification of lithium containing solutions of the present invention further provides a method for the purification of semi-pure or part-purified LiCl solution obtained as may be produced as described above from a brine by using an adsorbent. The combined processing method further comprises passing the semi-pure LiCl solution obtained after desorption of adsorbent to a graphene based filter medium, for example a graphene based membrane. The graphene based membrane is, in one form, prepared from graphene oxide (GO) or reduced graphene oxide (rGO), which allows appropriate permeation through the membrane.

### EXAMPLE 9

### Graphene Filter Medium Preparation—GO Membrane

Graphene oxide dispersion is prepared by the ultra-sonication of graphite oxide powder in water and subsequent centrifugation. The vacuum filtration of the as-prepared solution on a first support, for example an anodic alumina disc, provides with subsequent drying a free-standing graphene oxide (GO) membrane. The GO membrane is then glued onto a second support, for example a copper plate having a 2 cm aperture provided in the centre thereof, for the conduct of permeation experiments.

### EXAMPLE 10

### Permeation Experiments

The permeation experiment was carried out such that the GO membranes, supported by the copper plate, were clamped between two O-rings and then fixed between feed and permeate compartments to provide a leak tight environment. The part-purified LiCl solution obtained after desorption from the adsorbent was used as feed and deionized water in the permeate side. As a result of the concentration gradient across the membrane, ions tend to diffuse through the membrane and reach the permeate side. Permeate solution is collected after 24 h and chemical analysis is conducted to quantify the ions in the permeate side.

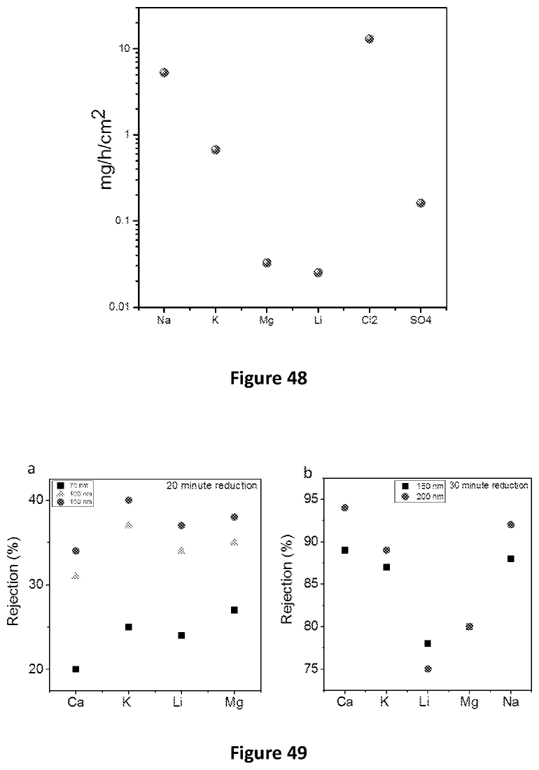

The percentage of rejection for Mg²⁺ ion is 94% whereas 45% for Li⁺, Na⁺ and K⁺ ions. In FIG. 48, it can be seen that Na⁺ and Cl⁻ ion permeation through GO is faster than other ions. The Applicants understand this demonstrates the potential of GO membranes for the selective removal of salt from the concentrated brine solution.

The results are shown in the following table and in FIG. 48.

TABLE 8

| | Na | K | Mg | | | SO4 |
|---|---|---|---|---|---|---|
| | (mg/L) | (mg/L) | (mg/L) | Li (mg/L) | Cl (mg/L) | (mg/L) |
| Feed | 111,000 | 9,420 | 3,360 | 302 | 180,000 | 14,000 |
| Feed (ICP data) | 47630 | 5495 | 2614 | 224 | 102,870 | 9,778 |
| Permeate (ICP | 25,205 | 3,203 | 155 | 120 | 62,237 | 768 |
| data) | | | | | | |
| Ratio | 1.89 | 1.71 | 16.86 | 1.87 | 1.65 | 12.73 |
| (feed:Permeate) | | | | | | |

### Pressure Filtration Using GO Membrane

To investigate the feasibility of using GO membrane in separating aqueous LiCl species from control aqueous brine or selective removal certain ions in the brine pressure filtration experiments were performed using a Sterlitech HP4750™ stirred cell. For pressure filtration, porous Poly ether sulfone (PES) was used as a substrate to increase the mechanical integrity of the membrane. To obtaining a reasonable flux we optimised the GO membrane thickness to 200-500 nm. The typical area used for pressure filtration was 1-2 cm². GO membrane on PES was then fixed inside the stirred cell using a rubber 0-ring to avoid any possible leakage in the experiment. Brine solution was used as a feed solution and collected the water on filtrate side by applying a pressure of 10 bar using a compressed nitrogen gas cylinder.

Salt concentration on the filtrate side was analysed by checking the conductivity of the water solution and found that total salt rejection is 20%.

### Preparation of rGO Membranes

GO membranes on PES substrates were found to be disintegrating after long time exposure to brine solution at high pressure and to resolve this issue we have partially reduced GO membrane with ascorbic acid. Partial reduction of GO decreased the amount of functional groups present in the membrane and subsequently reduced the hydrophilicity and wettability of the membrane. The ascorbic acid reduced graphene oxide (rGO) is found to be more stable in brine solution after long exposure.

### Permeation Through rGO Membrane

As per the GO membranes referred to above, rGO membranes deposited on PES substrate (˜5 cm dia membrane) were evaluated with pressure filtration. Even though the membrane is more stable after partial reduction, under high pressure, rGO layer from the PES got peeled off and damaged during the filtration. This suggests that reduced functional groups on rGO may have decreased the adhesion between the rGO layer and PES substrate. It is understood that increasing the adhesion of the rGO layer to PES will be possible by surface modification of PES with a polyelectrolyte.

### EXAMPLE 10

### Graphene Filter Medium Preparation—rGO Membrane

An aqueous suspension of graphene oxide was prepared by dispersing millimeter-sized graphite oxide flakes (purchased from BGT Materials Limited) in distilled water using bath sonication for 15 hours. The resulting dispersion was centrifuged 6 times at 8000 rpm to remove the multilayer GO flakes. The concentration of as prepared GO solution was 0.1 mg/ml. To improve the stability of GO membrane in brine solution we have partially reduced the GO with ascorbic acid. 1 ml of 0.17 mg/ml vitamin C was mixed with 1 ml GO solution and then the whole mixture was diluted to a volume of 20 ml. The pH of the mixed solution was adjusted to about 9-10 with 25% ammonia solution to promote the colloidal stability of the GO nanosheets. The solution was then heated at 90 degrees for 30 minutes in water bath to finish the reduction process.

Modified GO membranes were then prepared from the partially reduced GO (rGO) solution via vacuum filtration through a PES membrane with 0.22 um pore size. In order to increase the adhesion between partially reduced GO membrane and PES substrate, we coated a very thin polymer film on the surface of the PES substrate. The polymer used was Poly(diallyldimethylammonium chloride), which is a positively charged polymer. The positively charged Poly(diallyldimethylammonium chloride) tightly bonded the GO membrane and PES substrate via the electrostatic forces. After coating, the coated PES membrane was stored in the vacuum oven for two hours at 50° C. before depositing the partially reduced GO via vacuum filtration.

Modified graphene-based membranes with improved adhesion and stability were prepared and tested for the membrane performance. Modified membranes were found stable in the brine solution and survived up to 20 Bar pressure. Membranes with different thickness, ranging from 30 nm to 200 nm, and different partial reduction conditions (reduction time) were prepared and their filtration properties via pressure filtration. Membranes having 150-200 nm thickness with 30 minute GO reduction time provided the best filtration performance. Typical water flow rate observed for 150-200 nm thickness were ˜0.5 L/h/M2/Bar. All the filtration experiments were performed with 10 times diluted brine solution, because, due to the high osmotic pressure of the pure brine solution, no detectable water flux was observed. FIG. 49 shows the filtration performance of modified GO membranes with different thickness (FIG. 49a) and different reduction time (FIG. 49b).

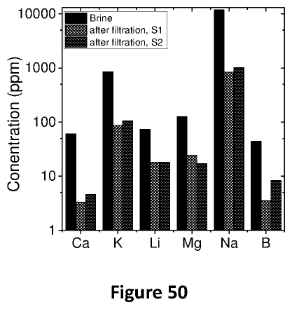

FIG. 50 shows the concentration of salts in brine solution before and after filtration through the modified GO membrane. Y-axis-log scale. S1 and S2 represent data from two different membranes. Membrane used is 200 nm thick and 30 minute reduced GO.

TABLE 9
Salt content after and before filtration (membrane
used - 200 nm, 30 minute reduced GO)

| | Ca | K | Li | Mg | | B |
|---|---|---|---|---|---|---|
| Sample | (PPM) | (PPM) | (PPM) | (PPM) | Na (PPM) | (PPM) |
| 10 times | 60.48 | 850.37 | 73.54 | 125.07 | 11738.98 | 44.06 |
| diluted brine | | | | | | |
| (feed) | | | | | | |
| % content | 0.46 | 6.5 | 0.57 | 0.97 | 91.0 | 0.34 |
| After | 3.3 | 87 | 18.1 | 24.5 | 837.7 | 3.5 |
| filtration | | | | | | |
| % content | 0.33 | 8.9 | 1.9 | 2.5 | 85.9 | 0.35 |
| after | | | | | | |
| filtration | | | | | | |
| Salt | 94% | 89% | 75% | 80% | 92% | 92% |
| Rejection | | | | | | |

The above experiments clearly show that all the salts in the brine solutions are rejected by the membrane with different rejection rate. Li salts gave least rejection (75%) with respect to other salts. The difference in rejection between Na and Li is ˜20.

It is understood that the nano-channels and/or interlayer galleries formed between the nano-sheets of, for example, GO or rGO, act as ion-sieves.

It is particularly envisaged that the first and second purification steps may comprise more than a single stage, pass or repeat of contact or exposure between the lithium containing solution passed to them and the adsorbent or graphene based filter medium, respectively, to realise the most significant benefits of the combination process of the present invention.

As can be seen with reference to the above description, a particular advantage is realised in accordance with the present invention in that the nanotube/fibre adsorbents of the present invention can be readily separated from a liquid after the sorption by filtration, sedimentation, or centrifugation because of their fibril morphology. It is expected that this will significantly reduce the cost of separation of the adsorbent from the liquid.

As can further be seen with reference to the above description, in one form the present invention provides a process to separate and purify LiCl and reduce or eliminate impurities in LiCl solutions to concentrations acceptable for use as a pre-cursor in high purity applications such as lithium ion batteries. This purification is achieved as described hereinabove. The preferred process according to the present invention specifically provides a method of reducing the contaminant impurities in the LiCl solution to less than about 20 ppm.

As demonstrated above, the Applicants have found that the graphene based filter medium works most effectively if presented with a relatively dilute lithium containing solution, as opposed to being presented with what may be termed a ‘raw’ brine. Such a raw brine is typically near saturated with sodium chloride. The part-purified lithium containing solution from the first purification step has been determined by the Applicants to be an appropriate if not ideal feed to the second purification step and is such that the graphene based filter medium may operate effectively to provide the further purified lithium containing solution of the present invention.

It is further understood that the combination of the techniques of adsorption and filtration using a graphene filter medium is particularly advantageous in the production of substantially purified lithium solutions, particularly lithium chloride solutions. One basis for this apparent synergy in the combination of the adsorption and filtration appears to be the effectiveness of adsorption in removing sodium ions, in particular, which in turn ensures that the part-purified lithium containing solution that is then passed to the graphene based filter medium is able to be further purified effectively thereby.

Again with reference to the above description, the present invention provides an improved extraction method for the extraction of lithium from a LiCl containing brine. Preferred processes according to the present invention are envisaged as being able to meet the needs and demands of today's lithium ion battery industry.

Preferred processes according to the present invention specifically provide a method of reducing the contaminant impurities in the brine to less than 20 ppm.

Modifications and variations such as would be apparent to the skilled addressee are considered to fall within the scope of the present invention.

1-41. (canceled)

42. A combined processing method for the purification of lithium containing solutions, the method comprising the method steps of passing a lithium containing solution to a first purification step in which the lithium containing solution is contacted with a titanate adsorbent whereby lithium ions are adsorbed thereon whilst rejecting substantially all other cations, the recovery of lithium from the adsorbent providing a part-purified lithium containing solution, the part-purified lithium containing solution produced in the first purification step is then passed in whole or part to a second purification step in which a graphene based filter medium is utilised to provide a further purified lithium containing solution.

43. The method of claim 42, wherein the lithium containing solution is a lithium containing brine.

44. The method of claim 42, wherein the adsorbent is provided in the form of either a hydrated titanium dioxide or a sodium titanate.

45. The method of claim 42, wherein the further purified lithium containing solution is a substantially pure lithium chloride solution.

46. The method of claim 42, wherein the brine contains impurities from the group of sodium, potassium, magnesium, calcium and borate, and the impurity concentration does not exceed about 20 ppm.

47. The method of claim 43, wherein the brine contains lithium in the range of about 500 to 1500 ppm, and impurities including magnesium in the range of about 0.15% to 0.30%, calcium in the range of about 0.05% to 0.1%, sodium in the range of about 8 to 10%, potassium in the range of about 0.7% to 1.0%, and borate in the range of about 0.15% to 0.20%.

48. The method of claim 43, wherein the brine solution is adjusted to a pH of 7 through the addition of a base.

49. The method of claim 42, wherein the contact between the lithium containing solution and the adsorbent takes place at or about room or ambient temperature.

50. The method of claim 49, wherein the contact or residence time between the brine solution and the adsorbent is:
a) between about 4 to 24 hours;
b) between about 20 to 24 hours; or
c) between about 8 to 16 hours.

51. The method of claim 42, wherein the recovery of lithium from the adsorbent is achieved through the regeneration of the adsorbent by the addition of an acid solution and the adsorbed lithium is extracted to provide the part purified lithium containing solution.

52. The method of claim 51, wherein the acid solution is a solution of hydrochloric acid.

53. The method of claim 51, wherein the amount of lithium extracted from the adsorbent through exposure to the acid solution is:
a. greater than about 90%; or
b. about 100%.

54. The method of claim 42, wherein the graphene based filter medium of the second purification step comprises a graphene membrane formed of one or more graphene, graphene oxide and/or reduced graphene oxide and to which the part-purified lithium containing solution is presented.

55. The method of claim 54, wherein the passing of the part purified lithium containing solution to the second purification step produces a filtrate or permeate that is enriched in relative terms in lithium ions, providing the further purified lithium containing solution.

56. The method of claim 54, wherein the second purification step is conducted under pressure.

57. The method of claim 42, wherein the further purified lithium containing solution is suitable is suitable for use in the production of battery grade lithium chemicals.

58. The method of claim 42, wherein the graphene is provided as a graphene oxide membrane formed in turn from graphite oxide powder.

59. The method of claim 54, wherein the graphene oxide membrane is reduced by way of exposure to ascorbic acid.

60. The method of claim 54, wherein the membrane is supported by a porous substrate.

61. The method of claim 54, wherein the graphene membrane has a thickness of between:
c. 30 to 200 nm; or
d. 150 to 200 nm.

62. The method of claim 42, wherein the level of salt rejection achieved by the second purification step is 20% or greater as measured by the conductivity of a permeate relative to that of the part-purified lithium containing solution.

63. The method of claim 62, wherein lithium is the least rejected ion or salt of the second purification step.

64. The method of claim 1, wherein the first and second purification steps comprise one or more stages, passes or repeats of contact or exposure between the lithium containing solution passed to them and the adsorbent or filter medium, respectively.
